(19) United States
(12) Patent Application Publication
(10) Pub. No.: US 2005/0249429 A1
(43) Pub. Date: Nov. 10, 2005

(54) Method, apparatus, and program for image processing

(75) Inventor: Yoshiro Kitamura, Kanagawa-ken (JP)

Correspondence Address: BIRCH STEWART KOLASCH & BIRCH, PO BOX 747, FALLS CHURCH, VA, 22040-0747, US

(73) Assignee: Fuji Photo Film Co., Ltd., Minamiashigara-shi (JP)

(21) Appl. No.: 11/110,753

(22) Filed: Apr. 21, 2005

(30) Foreign Application Priority Data
Apr. 22, 2004 (JP) 126835/2004

(51) Int. Cl. G03B 17/00

(52) U.S. Cl. 382/255; 396/254

(57) ABSTRACT

Blur information on an image is found appropriately. Blur analysis means calculates a degree of blur and a direction of blur by using pupil images of the image obtained by pupil detection means, and judges whether or not the image is a blurry image. For the image having been judged as a blurry image, a degree of shake and a width of blur are calculated from the pupil images, and the degree of blur, the width of blur, the direction of blur, and the degree of shake obtained from the pupil images are output as the blur information of the image to deblurring means. The deblurring means corrects the image based on the blur information, and obtains a corrected image.

### BACKGROUND OF THE INVENTION

1. Field of the Invention

The present invention relates to an image processing method and an image processing apparatus for obtaining blur information on digital photograph images. The present invention also relates to a program for causing a computer to execute the image processing method.

2. Description of the Related Art

Digital photograph images are obtained by photography with a digital still camera (DSC) or by photoelectrically reading photograph images recorded on a photographic film such as a negative film and a reversal film with a reading device such as a scanner, and printed after having been subjected to various kinds of image processing thereon. Deblurring processing for correcting a blur in a blurry image is one type of such image processing.

As causes of blurry images are listed poor focus due to poor adjustment of focal length and camera shake (hereinafter simply referred to as shake) caused by movement of hands of a photographer. In the case of poor focus, a point in a subject spreads two dimensionally in a photograph image. In other words, the point spreads without a specific direction thereof in the corresponding image. On the other hand, in the case of shake, a point in a subject moves along a path and is smeared one dimensionally in a photograph image. In other words, the point is smeared with directionality in the corresponding image.

In the field of digital photograph images, various kinds of methods have been proposed for restoring blurry images. If information on direction and length of shake can be obtained at the time of photography of an image, the image can be corrected by applying a restoration filter such as Wiener filter or an inverse filter to the image. Therefore, a method has been proposed in U.S. Patent Application Publication No. 20030002746, for example. In this method, a device (such as an acceleration sensor) enabling acquisition of information on the direction and length of shake at the time of photography is installed in an imaging device, and image restoration processing is carried out based on the information.

Another image restoration method is also known. In this method, a degradation function is set for a blurry image, and the blurry image is corrected by a restoration filter corresponding to the degradation function that has been set. The image after correction is then evaluated, and the degradation function is set again based on a result of the evaluation. This procedure of restoration, evaluation, and setting of the degradation function is repeated until a desired image quality can be achieved. However, this method is time-consuming, since the procedure needs to be carried out repeatedly. Therefore, in Japanese Unexamined Patent Publication No. 7(1995)-121703, a method has been described for improving processing efficiency. In this method, a user specifies a small area including an edge in a blurry image, and the procedure of restoration, evaluation, and setting of the degradation function is repeatedly carried out on the small area that has been specified, instead of the entire blurry image. In this manner, the degradation function is found optimally, and a restoration filter corresponding to the degradation function is then applied to the blurry image. In this manner, an amount of calculation is reduced by using the small area for finding the degradation function.

Meanwhile, following the rapid spread of mobile phones, functions thereof are improving. Especially, attention has been paid to improvement in functions of a digital camera embedded in a mobile phone (hereinafter simply called a phone camera). The number of pixels in a phone camera has reached 7 figures, and a phone camera is used in the same manner as an ordinary digital camera. Photography of one's favorite TV or sports personality with a phone camera has become as common as photography on a trip with friends. In a situation like this, photograph images obtained by photography with a phone camera are enjoyed by display thereof on a monitor of the phone camera and by printing thereof in the same manner as photograph images obtained by an ordinary digital camera.

However, since a mobile phone is not produced as a dedicated photography device, a mobile phone embedded with a digital camera is ergonomically unstable to hold at the time of photography. Furthermore, since a phone camera does not have a flash, a shutter speed is slower than an ordinary digital camera. For these reasons, when a subject is photographed by a phone camera, camera shake tends to occur more frequently than in the case of an ordinary camera. If camera shake is too conspicuous, the camera shake can be confirmed on a monitor of a phone camera. However, minor camera shake cannot be confirmed on a monitor, and becomes noticeable only after printing of an image. Therefore, deblurring processing is highly needed regarding a photograph image obtained by photography with a phone camera.

However, how to downsize mobile phones is one of key points in competition for manufacturers of mobile phones, in addition to performance and cost thereof. Therefore, installation of a device for obtaining information on direction and length of shake in a phone camera is not realistic. Therefore, the method in U.S. Patent Application Publication No. 20030002746 cannot be applied to a phone camera.

The method described in Japanese Unexamined Patent Publication No. 7(1995)-121703 is also problematic in terms of processing efficiency, since the method needs repetition of the procedure comprising degradation function setting, restoration, evaluation, and degradation function setting again.

Meanwhile, as has been described above, since a blur causes a point to spread in a blurry image, an edge in a blurry image also spreads in accordance with the spread of point. In other words, how the edge spreads in the image is directly related to the blur in the image. By paying attention to this fact, a method can be proposed for obtaining information such as direction and width of blur in an image through analysis of an edge in the image according to image data.

This method for obtaining the information on a blur in an image by analysis of a state of an edge in the image results in improper analysis in the case of presence of a gradation-like blurry edge in the image, which is also problematic.

### SUMMARY OF THE INVENTION

The present invention has been conceived based on consideration of the above circumstances. An object of the present invention is therefore to provide an image processing method, an image processing apparatus, and an image processing program for achieving a desirable correction effect by enabling appropriate acquisition of information on a blur in a digital photograph image including a part having gradation, without a specific device installed in an imaging device.

An image processing method of the present invention is a method of obtaining blur information representing a state of a blur in a digital photograph image, and the image processing method comprises the steps of:
detecting a point-like part in the digital photograph image; and
obtaining the blur information of the digital photograph image by using image data of the point-like part.

Finding the blur information by using the image data of the point-like part refers to analysis of a state of an edge in the image of the point-like part by using the image data of the point-like part, for example.

In the case where the digital photograph image is a photograph image of a person, it is preferable for the point-like part to be a pupil of the person. In addition, a clear facial outline may be designated as the point-like part. Although facial outlines are not points, they will be considered to be a type of point-like part in the present specification.

The blur information refers to information that can represent the state of the blur in the digital photograph image. For example, the blur information can be information on a direction of the blur and a width of the blur. As has been described above, poor focus causes the blur to spread without specific direction thereof and shake causes the blur to spread with directionality. In the case of shake, the direction of the blur is the direction of the shake. In the case of poor focus, the direction of the blur can be any direction. The width of the blur refers to a width thereof in the direction of the blur. For example, the width of the blur refers to an average edge width in the direction of the blur. In the case of poor focus causing the blur to spread without specific direction, the width of the blur may be an edge width in an arbitrary direction. Alternatively, the width of the blur may be an average edge width in the entire image.

The digital photograph image in the present invention may be a non-blur image not affected by poor focus or shake. For such a non-blur image, the blur information includes the width of the blur that is not larger than a predetermined threshold value, for example.

In the image processing method of the present invention, all items of the blur information may be found by using the image data of the point-like part. However, in the case where the digital photograph image has been affected by shake (that is, in the case where the information on the direction of the blur includes the fact that the blur is actually a shake having directionality and information on the direction of the shake), it is preferable for the information on the direction of the shake to be obtained by using the image data of the point-like part. In this case, the items of the blur information other than the information on the direction of the shake (such as the width of the blur) is preferably obtained by using entire data of the digital photograph image, based on the direction of the shake.

The information on the direction of the blur can be obtained by:
detecting an edge in different directions in the image of the point-like part;
obtaining a characteristic quantity of the edge in each of the directions; and
obtaining the information on the direction of the blur based on the characteristic quantity in each of the directions.

The characteristic quantity of the edge refers to a characteristic quantity related to how the edge spreads in the image. For example, the characteristic quantity includes sharpness of the edge and distribution of sharpness of the edge.

Any parameter can be used for the sharpness of the edge as long as the sharpness of the edge can be represented thereby. For example, in the case of an edge represented by a profile shown in FIG. 22, the sharpness of the edge can be represented by an edge width so that a degree of the sharpness becomes lower as the edge width becomes wider. Alternatively, the sharpness of the edge can be represented by a gradient of the profile so that the sharpness of the edge becomes higher as a change (the gradient of the profile) in lightness of the edge becomes sharper.

The different directions refer to directions used for finding the direction of the blur in a target image. The directions need to include a direction close to the actual direction of the blur. Therefore, the larger the number of the directions, the higher the accuracy of finding the direction of the blur becomes. However, in order to compensate for processing speed, it is preferable for the different directions to be set appropriately, such as 8 directions shown in FIG. 21, for example.

An image processing apparatus of the present invention is an apparatus for obtaining blur information representing a state of a blur in a digital photograph image, and the image processing apparatus comprises:
point-like part detection means for detecting a point-like part in the digital photograph image; and
analysis means for obtaining the blur information of the digital photograph image by using image data of the point-like part.

In the case where the digital photograph image is a photograph image of a person, it is preferable for the point-like part detection means to detect a pupil or a facial outline of the person as the point-like part. As a detection method, facial detecting techniques, which will be described later, may be employed. Alternatively, morphology filters, such as those utilized in detecting breast cancer, may be employed.

The blur information includes information on a direction of the blur. The information on the direction of the blur comprises information representing whether the blur has been caused by poor focus resulting in no directionality of the blur or shake resulting in directionality of the blur, and information representing a direction of the shake in the case where the blur has been caused by the shake. In this case, it is preferable for the analysis means to obtain the information on the direction of the blur by using the image data of the point-like part and to obtain the blur information other than the information on the direction of the blur by using entire data of the digital photograph image based on the information on the direction of the blur representing that the blur has been caused by the shake.

The analysis means preferably:
detects an edge in different directions in the image of the point-like part;
obtains a characteristic quantity of the edge in each of the directions; and
obtains the information on the direction of the blur based on the characteristic quantity in each of the directions.

The image processing apparatus of the present invention may further comprise correction means, for correcting the digital image after the analysis means obtains the blur information. The correction means may increase the degree of correction as the size of the point-like part increases. Increasing the degree of correction is not limited to varying the degree of correction according to the size of the point-like part, which is the size of the blur or shake. The correction means may correct images only in cases that the blur width is greater than or equal to a predetermined threshold value. Specifically, correction maybe administered only in cases that blur having blur widths greater than or equal to 1/10 the size of a facial width, or greater than or equal to the size of a pupil, are detected by blur analysis.

The image processing method of the present invention may be provided as a program for causing a computer to execute the image processing method.

According to the image processing method, the image processing apparatus, and the program of the present invention, the point-like part is detected in the digital photograph image, and the blur information of the digital photograph image is obtained by using the image data of the point-like part. Therefore, the blur information can be obtained without a specific device installed in an imaging device, and the blur information can be obtained properly even in the case where gradation is observed in the digital photograph image.

Furthermore, in the case where the blur in the digital photograph image has been caused by shake, the information on the direction of the shake is obtained by using the image data of the point-like shape. At the same time, the blur information other than the information on the direction of the shake, such as the information on the width of the blur (that is, a length of the shake, in this case), can be obtained from the data of the entire digital photograph image based on the information on the direction of the shake found from the image data of the point-like part by letting the length of the shake be represented by an average edge width in the entire digital photograph image in the direction of the shake represented by the information on the direction of the shake. In this manner, the information on the direction of the shake can be obtained properly. In addition, the information other than the direction of the shake, such as the information on the width of the blur, can be found more accurately, since an amount of data is enriched for finding the information other than the direction of the shake.

Note that the program of the present invention may be provided being recorded on a computer readable medium. Those who are skilled in the art would know that computer readable media are not limited to any specific type of device, and include, but are not limited to: CD's, RAM's ROM's, hard disks, magnetic tapes, and internet downloads, in which computer instructions can be stored and/or transmitted. Transmission of the computer instructions through a network or through wireless transmission means is also within the scope of this invention. Additionally, the computer instructions include, but are not limitedto: source, object, and executable code, and can be in any language, including higher level languages, assembly language, and machine language.

### BRIEF DESCRIPTION OF THE DRAWINGS

FIG. 1 is a block diagram showing the configuration of an image processing system A of a first embodiment of the present invention;

FIG. 2 is a block diagram showing the configuration of pupil detection means 100 in the image processing system A;

FIG. 3 is a block diagram showing the configuration of detection means 1 in the pupil detection means 100;

FIGS. 4A and 4B show positions of pupils;

FIGS. 5A and 5B respectively show an edge detection filter in horizontal direction and in vertical direction;

FIG. 6 shows calculation of a gradient vector;

FIGS. 7A shows a human face and FIG. 7B shows gradient vectors near the eyes and mouth in the face shown in FIG. 7A;

FIG. 8A shows a histogram of gradient vector magnitude before normalization, FIG. 8B shows a histogram of gradient vector magnitude after normalization, FIG. 8C shows a histogram of gradient vector magnitude represented by 5 values, and FIG. 8D shows a histogram of gradient vector magnitude represented by 5 values after normalization; FIG. 9 shows examples of face sample images used for generating reference data;

FIG. 10 shows other examples of face sample images used for generating reference data;

FIG. 11A to 11C show rotation of face;

FIG. 12 is a flow chart showing a procedure of generating the reference data;

FIG. 13 shows how recognizers are generated;

FIG. 14 shows alternation of target images;

FIG. 15 is a flow chart showing a procedure carried out by the detection means 1;

FIG. 16 shows operation of the pupil detection means 100;

FIG. 17 is a brightness histogram;

FIG. 18 shows an example of a weight table used by a voting unit 30 in the pupil detection means 100;

FIG. 19 is a flow chart showing a procedure carried out by the pupil detection means 100;

FIG. 20 is a block diagram showing the configuration of blur analysis means 200 in the image processing system A;

FIG. 21 shows an example of directions used at the time of edge detection;

FIG. 22 is a profile of an edge;

FIG. 23 is a histogram of edge width;

FIGS. 24A to 24C show operations of analysis means 220;

FIG. 25 shows calculation of a degree of blur;

FIGS. 26A to 26C show calculations of a degree of shake;

FIG. 27 is a flow chart showing a procedure carried out by the blur analysis means 200;

FIG. 28 is a block diagram showing the configuration of deblurring means 230;

FIG. 29 is a flow chart showing a procedure carried out by the image processing system A;

FIG. 30 is a block diagram showing the configuration of an image processing system B of a second embodiment of the present invention;

FIG. 31 is a block diagram showing the configuration of blur analysis means 300 in the image processing system B;

FIG. 32 is a flow chart showing a procedure carried out by the blur analysis means 300; and

FIG. 33 is a block diagram showing the configuration of deblurring means 350 in the image processing system B.

### DESCRIPTION OF THE PREFERRED EMBODIMENTS

Hereinafter, embodiments of the present invention will be described with reference to the accompanying drawings.

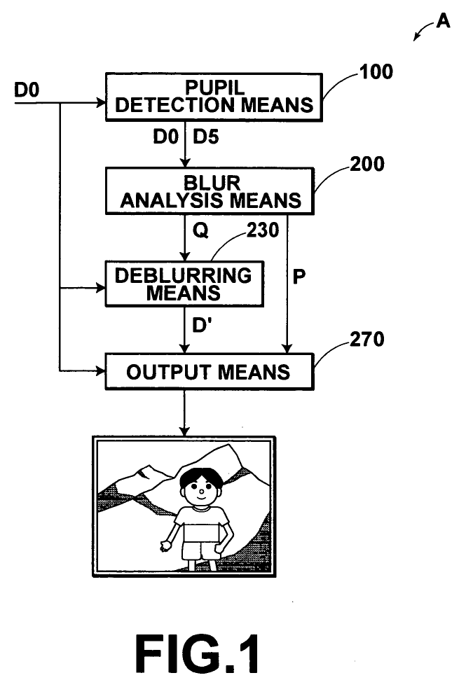

FIG. 1 is a block diagram showing the configuration of an image processing system A of a first embodiment of the present invention. The image processing system A in the first embodiment carries out deblurring processing on a digital photograph image (hereinafter simply referred to as an image) input thereto, and prints the image. The deblurring processing is carried out by executing a deblurring program read out to a storage device by using a computer (such as a personal computer). The deblurring program is stored in a recording medium such as a CD-ROM or distributed via a network such as the Internet to be installed in the computer.

Since image data represent an image, the image and the image data have the same meaning in the description below.

As shown in FIG. 1, the image processing system A in this embodiment has pupil detection means 100, blur analysis means 200, deblurring means 230, and output means 270. The pupil detection means 100 detects pupils in an image D0, and obtains images of the pupils (hereinafter referred to as pupil images) D5. The blur analysis means 200 analyzes a blur in the image D0 by using the pupil images D5 or the image D0, and judges whether or not the image D0 is a blurry image. The blur analysis means 200 also sends information P representing that the image D0 is not a blurry image to the output means 270 in the case where the image D0 is not a blurry image, and sends blur information Q to the deblurring means 230 in the case where the image D0 is a blurry image. The deblurring means 230 obtains a corrected image D′ by carrying out deblurring processing on the image D0 judged as a blurry image, based on the blur information Q obtained by the blur analysis means 200. The output means 270 obtains a print by printing the corrected image D′ obtained by the deblurring means 230 or the image D0 that is not a blurry image. Hereinafter, the respective means of the image processing system A will be described in detail.

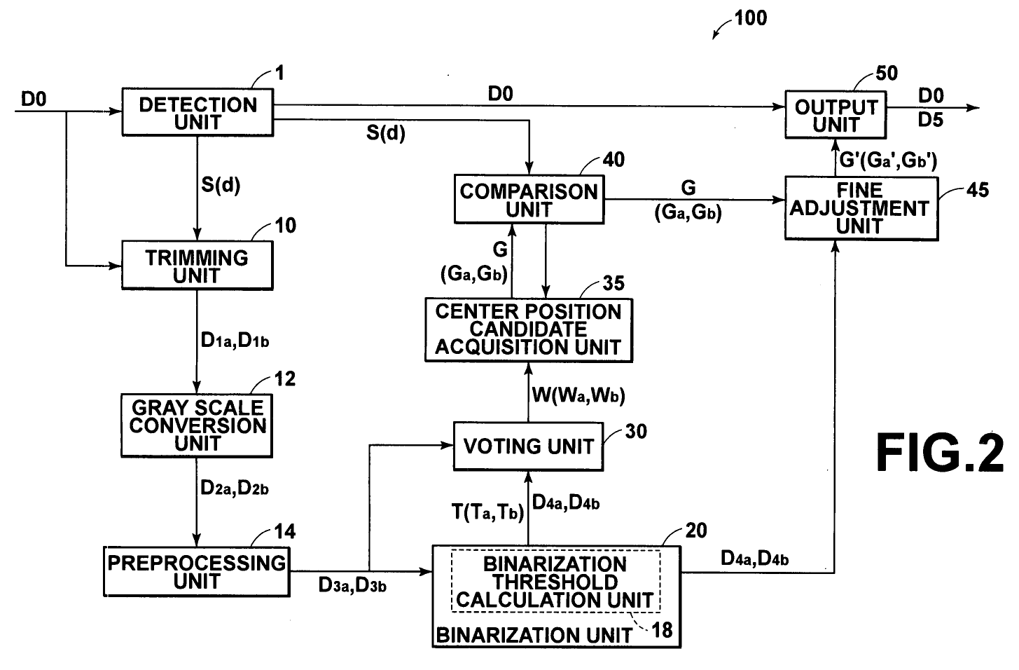

FIG. 2 is a block diagram showing the configuration of the pupil detection means 100 in the image processing system A. As shown in FIG. 2, the pupil detection means 100 comprises a detection unit 1, a trimming unit 10, a gray scale conversion unit 12, preprocessing unit 14, a binarization unit 20 comprising a binarization threshold calculation unit 18, a voting unit 30, a center position candidate acquisition unit 35, a comparison unit 40, a fine adjustment unit 45, and an output unit 50. The detection unit 1 judges whether or not the image D0 includes a face, and outputs the image D0 to the output unit 50 as it is in the case where the image D0 does not include a face. In the case where the image D0 includes a face, the detection unit 1 detects the right eye and the left eye, and outputs information S including positions of the eyes and a distance d between the eyes to the trimming unit 10 and to the comparison unit 40. The trimming unit 10 trims the image D0 based on the information S from the detection unit 1, and obtains trimmed images D1a and D1b including respectively the left eye and the right eye (hereinafter the images D1a and D1b are collectively called the images D1 in the case where the two images do not need to be distinguished). The gray scale conversion unit 12 carries out gray-scale conversion on the trimmed images D1, and obtains gray scale images D2 (D2a and D2b) from the images D1. The preprocessing unit 14 carries out preprocessing on the gray-scale images D2, and obtains preprocessed images D3 (D3a and D3b). The binarization threshold calculation unit 18 calculates a threshold value T for binarizing the preprocessed images D3. The binarization unit 20 carries out binarization on the preprocessed images D3 by using the binarization threshold value T calculated by the binarization threshold calculation unit 18, and obtains binarized images D4 (D4a and D4b). The voting unit 30 projects coordinates of each of pixels in the binary images D4 onto a space of Hough circle transform (this process is called “voting”), and obtains votes at each of points in the space. The voting unit 30 also calculates total votes W (Wa, and Wb) at each of the points having the same coordinates. The center position candidate acquisition unit 35 determines coordinates of the center of a circle corresponding to the largest total votes among the total votes obtained by the voting unit 30, as center position candidates G (Ga, and Gb). The center position candidate acquisition unit 35 also finds the center position candidates newly when the comparison unit 40 instructs the center position candidate acquisition unit to newly find the center position candidates. The comparison unit 40 judges whether or not the center position candidates obtained by the center position candidate acquisition unit 35 satisfy criteria, and outputs the center position candidates as center positions of the pupils to the fine adjustment unit 45 in the case where the center position candidates satisfy the criteria. The comparison unit 40 also causes the center position candidate acquisition unit 35 to newly obtain the center position candidates in the case where the center position candidates do not satisfy the criteria. The comparison unit 40 causes the center position candidate acquisition unit 35 to repeat acquisition of the center position candidates until the center position candidates satisfy the criteria. The fine adjustment unit 45 carries out fine adjustment on the center positions G (Ga, and Gb) of the pupils output from the comparison unit 40, and outputs final center positions G′ (G′a, and G′b) to the output unit 50. The output unit 50 cuts predetermined ranges surrounding the center positions G′a and G′b from the image D0, and obtains the pupil images D5 (D5a and D5b). The output unit 50 outputs the pupil images D5 to the blur analysis means 200. In the case where the image D0 does not include a face, the output unit 50 outputs the image D0 as it is to the blur analysis means 200.

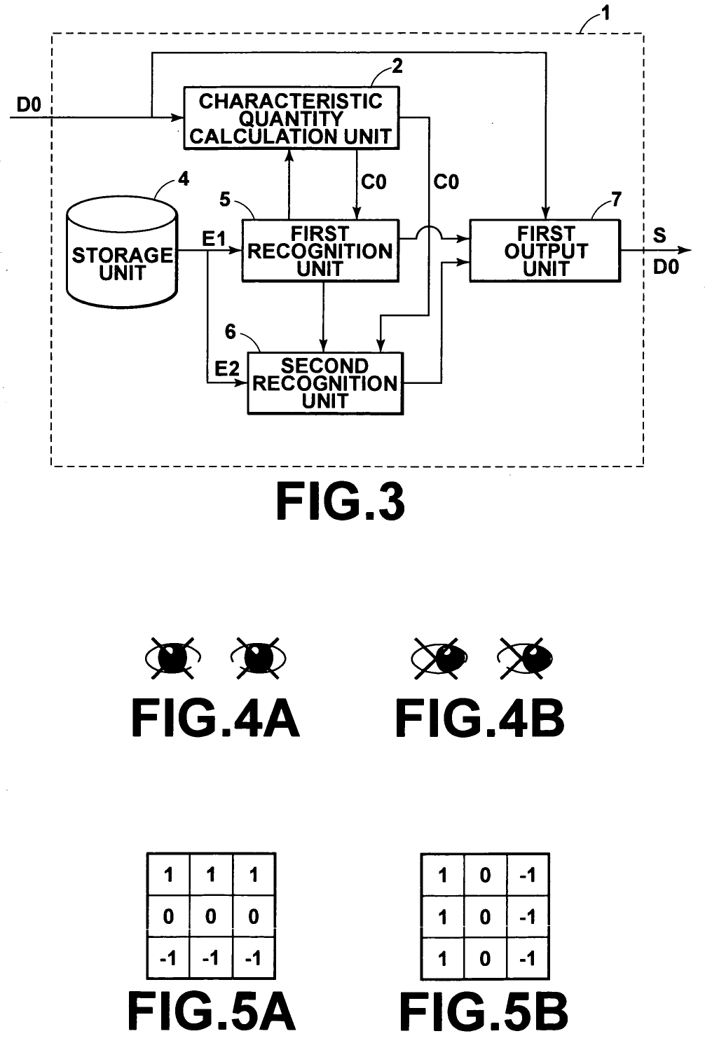

FIG. 3 is a block diagram showing the configuration of the detection unit 1 in the pupil detection unit 100. As shown in FIG. 3, the detection unit 1 comprises a characteristic quantity calculation unit 2 for calculating characteristic quantities C0 from the image D0, a storage unit 4 for storing a first reference data set E1 and a second reference data set E2 that will be described later, a first recognition unit 5 for judging whether a face is included in the image D0 based on the characteristic quantities C0 found by the characteristic quantity calculation unit 2 and on the first reference data set E1 stored in the storage unit 4, a second recognition unit 6 for judging positions of eyes included in the face based on the characteristic quantities C0 in the image of the face calculated by the characteristic quantity calculation unit 2 and based on the second reference data set E2 in the case where the image D0 has been judged to include the face, and a first output unit 7.

The positions of eyes detected by the detection unit 1 refer to positions at the center between the inner corner and tail of each of the eyes in the face (shown by X in FIG. 4). In the case where the eyes look ahead as shown in FIG. 4A, the positions refer to center positions of pupils. In the case of eyes looking sideways as shown in FIG. 4B, the positions fall on positions in pupils other than the center positions thereof or on the whites of eyes.

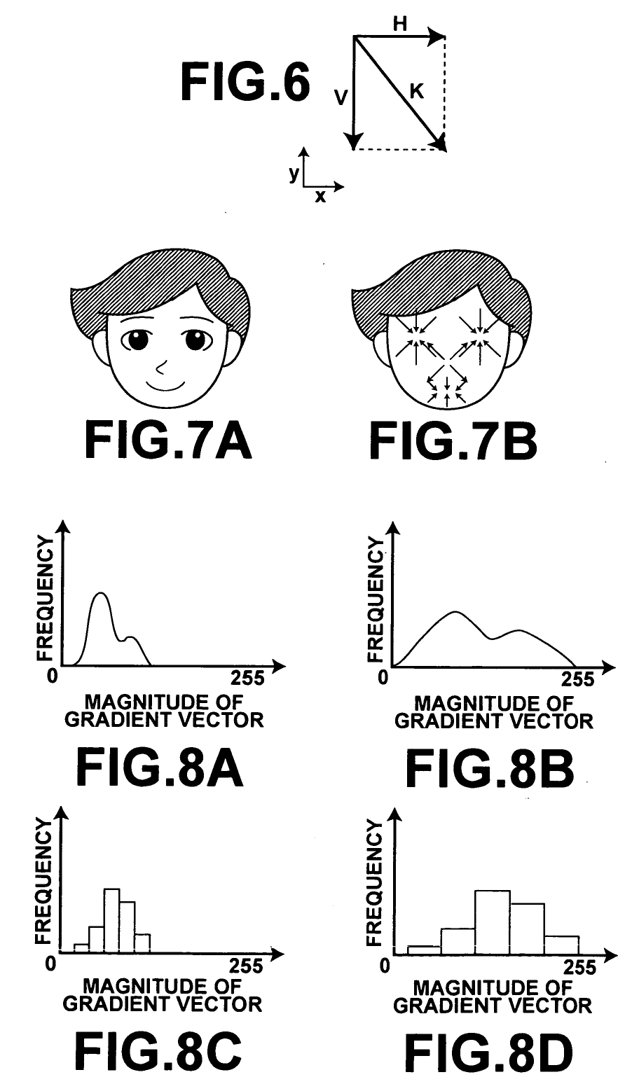

The characteristic quantity calculation unit 2 calculates the characteristic quantities C0 used for detection of face from the image D0. The characteristic quantity calculation unit 2 calculates the same characteristic quantities C0 from a face image extracted as will be described later in the case where the image D0 includes a face. More specifically, gradient vectors (that is, directions and magnitudes of changes in density in pixels in the original image D0 and the face image) are calculated as the characteristic quantities C0. Hereinafter, how the gradient vectors are calculated will be explained. The characteristic quantity calculation unit 2 carries out filtering processing on the original image D0 by using a horizontal edge detection filter shown in FIG. 5A. In this manner, an edge in the horizontal direction is detected in the original image D0. The characteristic quantity calculation unit 2 also carries out filtering processing on the original image D0 by using a vertical edge detection filter shown in FIG. 5B. In this manner, an edge in the vertical direction is detected in the original image D0. The characteristic quantity calculation unit 2 then calculates a gradient vector K at each pixel as shown in FIG. 6, based on magnitudes of a horizontal edge H and a vertical edge V thereat. The gradient vector K is calculated in the same manner from the face image. The characteristic quantity calculation unit 2 calculates the characteristic quantities C0 at each step of alteration of the original image D0 and the face image as will be explained later.

As shown in FIG. 7B, the gradient vectors K calculated in this manner point to the centers of eyes and mouth in dark areas such as eyes and mouth if the face shown in FIG. 7A is used for the calculation. In a bright area such as nose, the gradient vectors K point outward from the nose. Since the density changes are larger in the eyes than in the mouth, the magnitudes of the gradient vectors K are larger in the eyes than in the mouth.

The directions and the magnitudes of the gradient vectors K are used as the characteristic quantities C0. The directions of the gradient vectors K are represented by values ranging from 0 to 359 degrees from a predetermined direction (such as the direction x shown in FIG. 6).

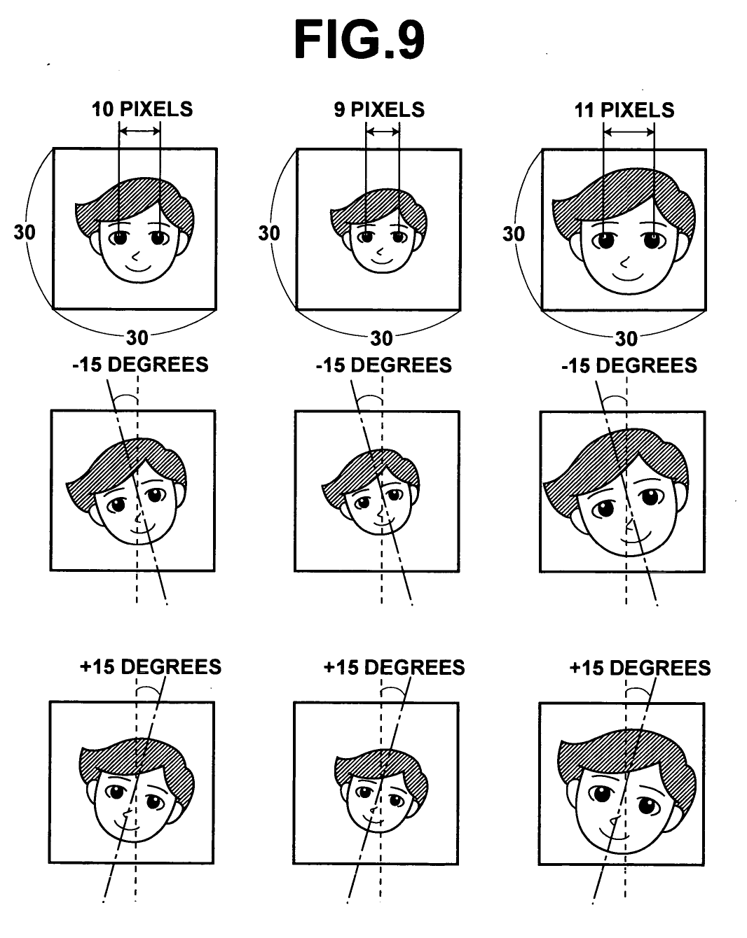

The magnitudes of the gradient vectors K are normalized. For normalization thereof, a histogram of the magnitudes of the gradient vectors K at all the pixels in the original image D0 is generated, and the magnitudes are corrected by smoothing the histogram in such a manner that distribution of the magnitudes spreads over entire values (such as 0˜255 in the case of 8-bit data) that the pixels in the original image D0 can take. For example, if the magnitudes of the gradient vectors K are small and the values in the histogram are thus spread mainly in smaller values as shown in FIG. 8A, the magnitudes are normalized so that the magnitudes can spread over the entire values ranging from 0 to 255, as shown in FIG. 8B. In order to reduce an amount of calculations, a range of value distribution in the histogram is preferably divided into 5 ranges as shown in FIG. 8C so that normalization can be carried out in such a manner that the distribution in the 5 ranges spreads over ranges obtained by dividing the values 0˜255 into 5 ranges.

The reference data sets E1 and E2 stored in the storage unit 4 define a recognition condition for a combination of the characteristic quantities C0 at each of pixels in each of pixel groups of various kinds comprising a combination of pixels selected from sample images that will be explained later.

The recognition condition and the combination of the characteristic quantities C0 at each of the pixels comprising each of the pixel groups are predetermined through learning of sample image groups including face sample images and non-face sample images.

In this embodiment, when the first reference data set E1 is generated, the face sample images are set to have 30×30 pixels and the distance between the center positions of eyes is set to 10, 9 or 11 pixels for the same face, as shown in FIG. 9. Measuring from a line perpendicular to the line connecting the eyes in the face without a tilt, the face is rotated in a range from −15 degrees to 15 degrees in 3-degree increment. In other words, the face is tilted in −15 degrees, −12 degrees, −9 degrees, −6 degrees, −3 degrees, 0 degrees, 3 degrees, 6 degrees, 9 degrees, 12 degrees, and 15 degrees for the same face in the face sample images. Therefore, 33 (=3×11) images are used for the same face in the face sample images. In FIG. 9, only the sample images tilted by −15 degrees, 0 degrees, and 15 degrees are shown. The center of rotation is the intersection of diagonal lines of each of the sample images. In the case where the number of pixels in the distance between the eyes is 10, the center in each of the eyes is located at the same position. The center positions are represented by coordinates (x1, y1) and (x2, y2) whose origin is the upper left corner of the face sample images. The positions of the eyes in the vertical direction (that is, y1 and y2) are the same in all the face sample images.

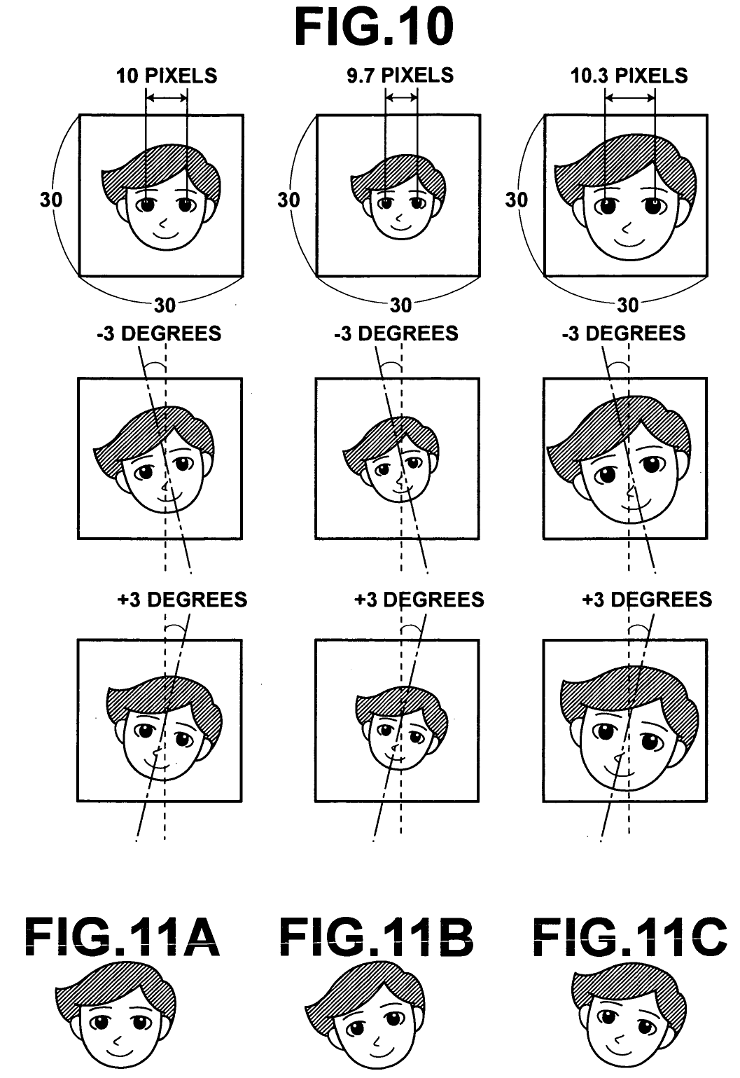

When the second reference data set E2 is generated, the face sample images are set to have 30×30 pixels, and the distance between the center positions of the eyes is set to 10, 9.7 and 10.3 pixels for the same face, as shown in FIG. 10. Measuring from a line perpendicular to the line connecting the eyes in the face without a tilt, the face is rotated in a range from −3 degrees to 3 degrees in 1-degree increment. In other words, the face is tilted by −3 degrees, −2 degrees, −1 degrees, 0 degrees, 1 degrees, 2 degrees, and 3 degrees for the same face in the face sample images. Therefore, 21 (=3×7) images are used for the same face in the face sample images. In FIG. 10, only the sample images tilted by −3 degrees, 0 degrees, and 3 degrees are shown. The center of rotation is the intersection of diagonal lines of each of the sample images. The positions of the eyes in the vertical direction are the same in all the face sample images. In order to set the distance between the eyes to become 10.3 and 9.7 pixels, the sample images having the distance of 10 pixels between the eyes are firstly enlarged or reduced by a magnification ratio of 1.03 and 0.97. The images after enlargement or reduction are then set to have 30×30 pixels.

The center positions of eyes in the sample images used for generating the second reference data set E2 are the positions of eyes to be recognized in this embodiment.

For the non-face sample images, any images having 30×30 pixels are used.

In the case where only the face sample images having the distance of 10 pixels between the eyes without face rotation (that is, the images whose degree of rotation is 0) are learned, images recognized as face images with reference to the first and second reference data sets E1 and E2 are face images without a tilt and having the distance of 10 pixels between eyes. However, since a face that may be included in the image D0 does not have a predetermined size, the image D0 needs to be enlarged or reduced as will be described later for judgment as to whether a face is included in the image D0 and as to the positions of eyes. In this manner, the face and the positions of eyes corresponding to the size in the face sample images can be recognized. In order to cause the distance between the eyes to become exactly 10 pixels, the image D0 is enlarged or reduced in a stepwise manner by using the magnification ratio of 1.1 while recognition of face and eye positions is carried out thereon. An amount of calculations in this case thus becomes extremely large.

Furthermore, a face that may be included in the image D0 may not be rotated as shown in FIG. 11A or may be rotated as shown in Figures 11B and 11C. However, in the case where only the face sample images with 0 degree of rotation and with the distance of 10 pixels between the eyes are learned, the images of the tilted faces in FIGS. 11B and 11C are not recognized as face images, which is not correct.

For this reason, in this embodiment, the face sample images having the distance of 9, 10, and 11 pixels between the eyes and having the rotation of 3-degree increment in the range from −15 to 15 degrees are used for generating the first reference data set E1. In this manner, when the first recognition unit 5 recognizes a face and the eye positions as will be describe later, the image D0 is enlarged or reduced in a stepwise manner by a magnification ratio of 11/9, which leads to a smaller amount of calculations than in the case where the image D0 is enlarged or reduced in a stepwise manner by using the magnification ratio of 1.1, for example. Furthermore, a face can be recognized even if the face is rotated as shown in FIGS. 11B or 11C.

When the second reference data set E2 is generated, the face sample images to be used therefor have the distance of 9.7, 10, and 10.3 pixels between the eyes and have the degree of rotation in the 1-degree increment in the range from −3 to 3 degrees, as shown in FIG. 10. Therefore, the ranges of the distance and rotation are smaller than in the case of the first reference data set E1. When the second recognition unit 6 recognizes a face and the eye positions as will be described later, the image D0 needs to be enlarged or reduced in a stepwise manner by using a magnification ratio of 10.3/9.7. Therefore, time necessary for calculation for the recognition becomes longer than the recognition by the first recognition unit 5. However, since the second recognition unit 6 carries out the recognition only in the face recognized by the first recognition unit 5, an amount of calculations becomes smaller for recognition of the eye positions than in the case of using the entire image D0.

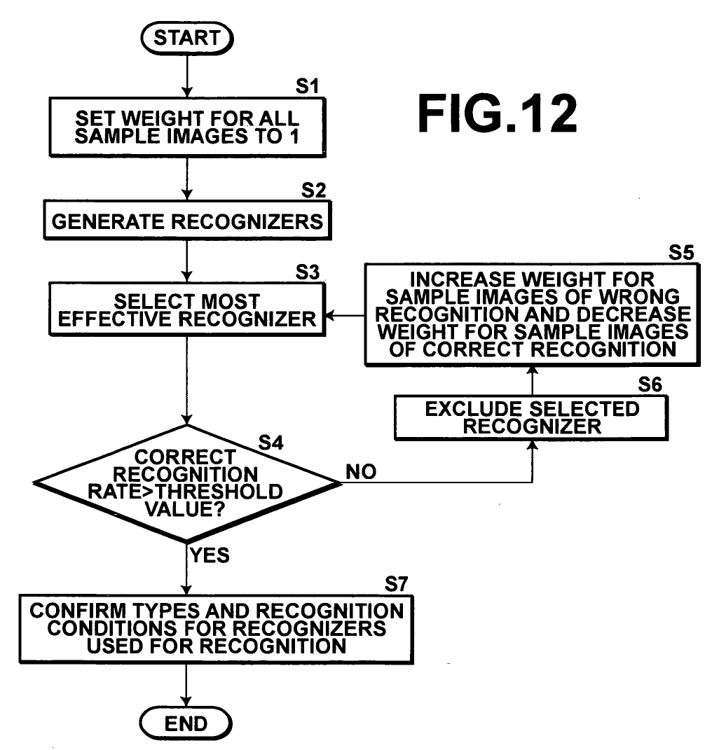

Hereinafter, an example of how the sample image group is learned will be described with reference to a flow chart shown in FIG. 12. How the first reference data set E1 is generated will be described below.

The sample image group comprises the face sample images and the non-face sample images. The face sample images have the distance of 9, 10 or 11 pixels between the eyes and are rotated in the 3-degree increment between −15 degrees and 15 degrees. Each of the sample images is assigned with a weight (that is, importance). The weight for each of the sample images is initially set to 1 (S1).

A recognizer is generated for each of the pixel groups of the various kinds in the sample images (S2). The recognizer provides a criterion for recognizing whether each of the sample images represents a face image or a non-face image, by using the combinations of the characteristic quantities C0 at the pixels in each of the pixel groups. In this embodiment, a histogram of the combinations of the characteristic quantities C0 at the respective pixels corresponding to each of the pixel groups is used as the recognizer.

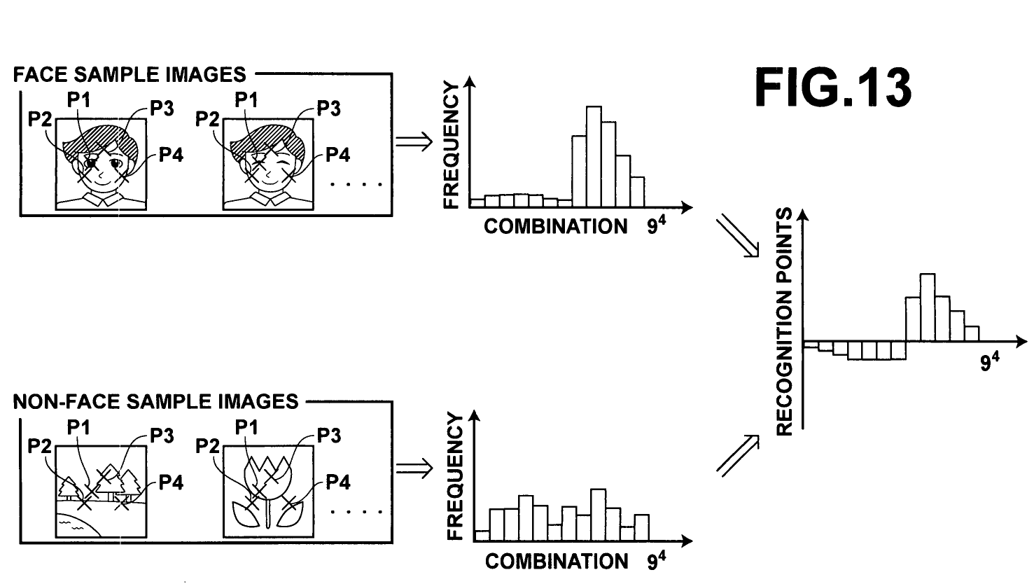

How the recognizer is generated will be described with reference to FIG. 13. As shown by the sample images in the left of FIG. 13, the pixels comprising each of the pixel groups for generating the recognizer include a pixel P1 at the center of the right eye, a pixel P2 in the right cheek, a pixel P3 in the forehead, and a pixel P4 in the left cheek in the respective face sample images. The combinations of the characteristic quantities C0 are found at each of the pixels P1˜P4 in the face sample images, and the histogram is generated. The characteristic quantities C0 represent the directions and the magnitudes of the gradient vectors K thereat. Therefore, since the direction ranges from 0 to 359 and the magnitude ranges from 0 to 255, the number of the combinations can be 360×256 for each of the pixels if the values are used as they are. The number of the combinations can then be (360×256)⁴ for the four pixels P1 to P4. As a result, the number of the samples, memory, and time necessary for the learning and detection would be too large if the values were used as they are. For this reason, in this embodiment, the directions are represented by 4 values ranging from 0 to 3. If an original value of the direction is from 0 to 44 and from 315 to 359, the direction is represented by the value 0 that represents a rightward direction. Likewise, the original direction value ranging from 45 to 134 is represented by the value 1 that represents an upward direction. The original direction value ranging from 135 to 224 is represented by the value 2 that represents a leftward direction, and the original direction value ranging from 225 to 314 is represented by the value 3 that represents a downward direction. The magnitudes are also represented by 3 values ranging from 0 to 2. A value of combination is then calculated according to the equation below:
value of combination=0 if the magnitude is 0 and
   value of combination=(the value of direction+1)×(the value of magnitude) if the value of magnitude>0.

In this manner, the number of the combinations becomes 9⁴, which can reduce the number of data of the characteristic quantities C0.

Likewise, the histogram is generated for the non-face sample images. For the non-face sample images, pixels corresponding to the positions of the pixels P1 to P4 in the face sample images are used. A histogram of logarithm of a ratio of frequencies in the two histograms is generated as shown in the right of FIG. 13, and is used as the recognizer. Values of the vertical axis of the histogram used as the recognizer are referred to as recognition points. According to the recognizer, the larger the absolute values of the recognition points that are positive, the higher the likelihood becomes that an image showing a distribution of the characteristic quantities C0 corresponding to the positive recognition points represents a face. On the contrary, the larger the absolute values of the recognition points that are negative, the higher the likelihood becomes that an image showing a distribution of the characteristic quantities C0 corresponding to the negative recognition points does not represent a face. At Step S2, the recognizers are generated in the form of the histograms for the combinations of the characteristic quantities C0 at the respective pixels in the pixel groups of various kinds that can be used for recognition.

One of the recognizers generated at Step S2 is selected as the recognizer that can be used most effectively for recognizing the face or non-face images. This selection of the most effective recognizer is made in consideration of the weight of each of the sample images. In this example, a weighted correct recognition rate is compared between the recognizers, and the recognizer having the highest weighted correct recognition rate is selected (S3). More specifically, the weight for each of the sample images is 1 at Step S3 when the procedure at Step S3 is carried out for the first time. Therefore, the recognizer by which the number of the sample images recognized as the face or non-face images becomes the largest is selected as the most effective recognizer. In the procedure at Step S3 carried out for the second time or later after Step S5 whereat the weight is updated for each of the sample images as will be explained later, the sample images have the various weights such as 1, larger than 1, or smaller than 1. The sample images whose weight is larger than 1 contributes more than the sample images whose weight is smaller than 1, when the correct recognition rate is evaluated. In this manner, in the procedure at Step S3 after Step S5, right recognition of the sample images whose weight is larger is more emphasized.

Judgment is made as to whether the correct recognition rate of a combination of the recognizers that have been selected exceeds a predetermined threshold value (S4). In other words, a rate representing how correctly each of the sample images is recognized as the face image or non-face image by using the combination of the recognizers that have been selected is examined. For this evaluation of the correct recognition rate, the sample images having the current weight or the sample images having the same weight may be used. In the case where the correct recognition rate exceeds the predetermined threshold value, recognition of the face image or non-face image can be carried out at a probability that is high enough, by using the recognizers that have been selected. Therefore, the learning ends. If the result is equal to or smaller than the threshold value, the procedure goes to Step S6 for further selecting another one of the recognizers to be combined with the recognizers that have been selected.

At Step S6, the recognizer that has been selected at immediately preceding Step S3 is excluded for not selecting the same recognizer.

The weight of the sample images which have not been recognized correctly as the face images or the non-face images by the recognizer selected at immediately preceding Step S3 are weighted more while the sample images whose recognition was correct at Step S3 are weighted less (S5). This procedure is carried out because the sample images whose recognition was not correctly carried out by the recognizers that have been selected are used more importantly than the sample images of correct recognition in the selection of the additional recognizer. In this manner, the recognizer than can carry out correct recognition on the heavily weighted sample images is selected in order to improve effectiveness of the combination of the recognizers.

The procedure then goes back to Step S3, and the effective recognizer is selected based on the weighted correct recognition rate, as has been described above.

If the correct recognition rate exceeds the predetermined threshold value at Step S4 when the recognizers corresponding to the combinations of the characteristic quantities at the respective pixels in a specific one of the pixel groups is selected as the recognizers that are appropriate for recognizing presence or absence of face by repeating the procedure from Step S3 to Step S6, the type of the recognizers and the recognition conditions used for recognition of presence or absence of face are confirmed (S7) to end the learning for the first reference data set E1.

Likewise, the second reference data set E2 is generated through finding of the type of the recognizers and the recognition conditions.

If the learning method described above is used, the recognizers can be any recognizers other than the histograms described above, as long as the recognizers can provide a criterion for distinction between face images and non-face images by using the combinations of the characteristic quantities C0 at the respective pixels comprising a specific one of the pixel groups. For example, the recognizers can be binary data, or threshold values, or functions. In the case of a histogram, a histogram representing distribution of differences between the histograms shown in the middle of FIG. 13 may also be used.

The method of learning is not necessarily limited to the method described above. A machine learning method such as a method using a neural network may also be adopted.

The first recognition unit 5 finds the recognition points for all the combinations of the characteristic quantities C0 at the respective pixels comprising each of the pixel groups, with reference to the recognition conditions learned from the first reference data set E1 regarding all the combinations of the characteristic quantities C0 at the respective pixels comprising the pixel groups. Whether the image D0 includes a face is judged through consideration of all the recognition points. At this time, the directions and the magnitudes of the gradient vectors K as the characteristic quantities C0 are represented by the 4 values and the 5 values, respectively. For example, in the case where the sum of all the recognition points is positive, the image D0 is judged to include a face. If the sum is negative, the image D0 is judged to not include a face. Recognition of presence or absence of a face in the image D0 carried out by the first recognition unit 5 is called first recognition below.

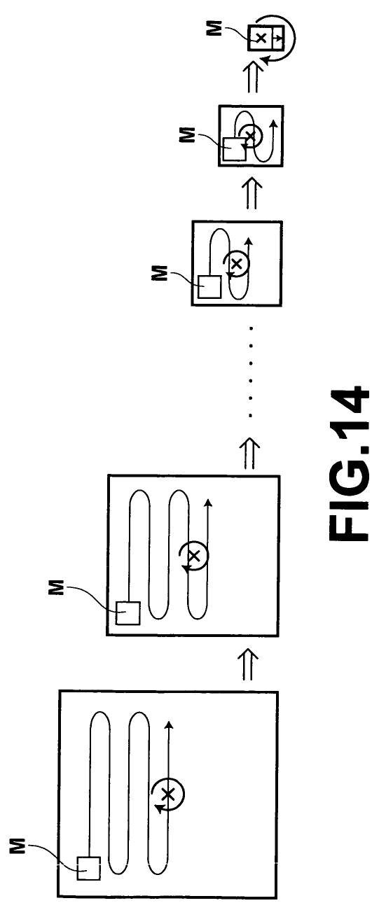

The face in the image D0 may have a different size from the faces in the sample images of 30×30 pixels. Furthermore, an angle of rotation of the face in two dimensions may not necessarily be 0. For this reason, the first recognition unit 5 enlarges or reduces the image D0 in a stepwise manner as shown in FIG. 14 (showing the case of reduction), for causing the vertical or horizontal dimension of the image D0 to become 30 pixels while rotating the image D0 by 360 degrees in a stepwise manner. A mask M of 30×30 pixels is set in the image D0 enlarged or reduced at each of the steps, and the mask M is shifted pixel by pixel in the enlarged or reduced image D0 for recognition of presence or absence of a face in the mask M in the image D0.

Since the sample images learned at the time of generation of the first reference data set E1 have 9, 10, or 11 pixels as the distance between the eyes, the magnification ratio for the image D0 is 11/9. Furthermore, since the range of face rotation is between −15 degrees and 15 degrees regarding the face sample images learned at the time of generation of the first and second reference data sets E1 and E2, the image D0 is rotated by 360 degrees in 30-degree increment.

The characteristic quantity calculation unit 2 calculates the characteristic quantities C0 at each alteration (enlargement or reduction and rotation) of the image D0.

The first recognition unit 5 judges whether the image D0 includes a face at each step of alteration. In the case where the image D0 has once been judged to include a face, the first recognition unit 5 extracts a face image of 30×30 pixels corresponding to a position of the mask M in the image D0 at the size and rotation angle used at the time of detecting the face.

The second recognition unit 6 finds the recognition points in the face image extracted by the first recognition unit 5 for all the combinations of the characteristic quantities C0 at the respective pixels comprising each of the pixel groups, with reference to the recognition conditions learned from the second reference data set E2 regarding all the combinations of the characteristic quantities C0 at the respective pixels comprising the pixel groups. The positions of the eyes in the face are judged through consideration of all the recognition points. At this time, the directions and the magnitudes of the gradient vectors K as the characteristic quantities C0 are represented by the 4 values and the 5 values, respectively.

The second recognition unit 6 enlarges or reduces the face image in a stepwise manner while rotating the face image by 360 degrees in a stepwise manner. The mask M of 30×30 pixels is set in the face image enlarged or reduced at each of the steps, and the mask M is shifted pixel by pixel in the enlarged or reduced face image for recognition of the eye positions in the image in the mask M.

Since the sample images learned at the time of generation of the second reference data set E2 have the distance of 9.7, 10 or 10.3 pixels between the eyes, the magnification ratio used at the time of enlargement or reduction of the face image is 10.3/9.7. Furthermore, since the faces in the face sample images learned at the time of generation of the reference data set E2 are rotated in the range from −3 degrees to 3 degrees, the face image is rotated by 360 degrees in 6-degree increment.

The characteristic quantity calculation unit 2 calculates the characteristic quantities C0 at each alteration (enlargement or reduction and rotation) of the face image.

In this embodiment, the recognition points are added at the respective steps of alteration of the extracted face image, and coordinates whose origin is at the upper left corner in the face image within the mask M of 30×30 pixels are set at the step of alteration generating the largest recognition points. Positions corresponding to the positions of eye centers (x1, y1) and (x2, y2) in the sample images are then found. The positions corresponding to the coordinates are judged to be the positions of eye centers in the image D0 before alteration.

The first output unit 7 outputs the image D0 as it is to the output unit 50 in the case where the image D0 has been judged to include no face. In the case where the first recognition unit 5 has judged that the image D0 includes a face, the first output unit 7 also finds the distance d between the eye centers based on the positions of eyes recognized by the second recognition unit 6. The first output unit 7 then outputs the distance d and the positions of the eye centers as the information S to the trimming unit 10 and to the comparison unit 40.

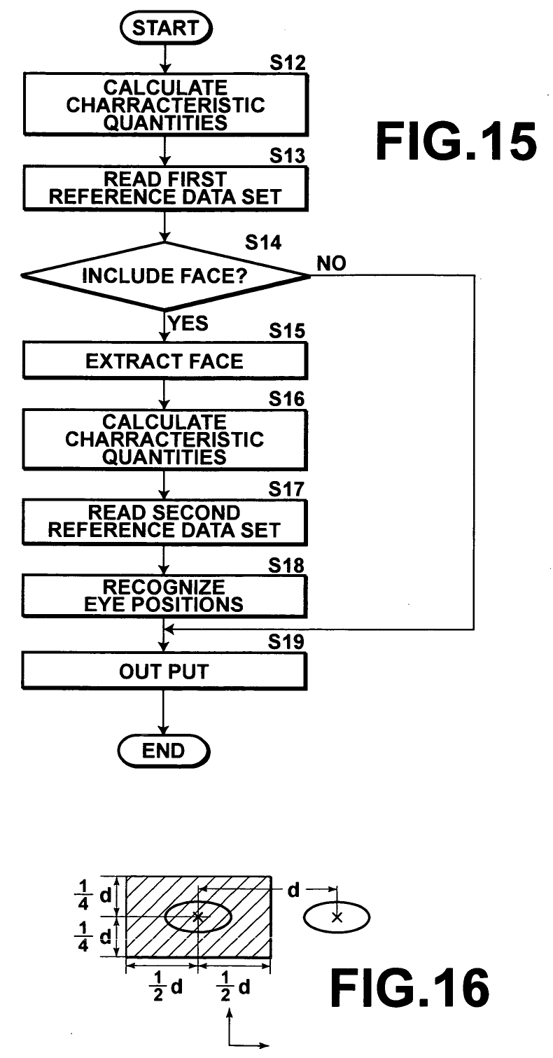

FIG. 15 is a flow chart showing a procedure carried out by the detection unit 1 in the pupil detection means 100. The characteristic quantity calculation unit 2 finds the directions and the magnitudes of the gradient vectors K as the characteristic quantities C0 in the image D0 at each of the steps of alteration (S12). The first recognition unit 5 reads the first reference data set E1 from the storage unit 4 (S13), and carries out the first recognition as to whether or not the image D0 includes a face (S14).

In the case where the first recognition unit 5 has judged that the image D0 includes a face (S14: Yes), the first recognition unit 5 extracts the face image from the image D0 (S15). The first recognition unit 5 may extract a plurality of face images in the image D0. The characteristic quantity calculation unit 2 finds the directions and the magnitudes of the gradient vectors K as the characteristic quantities C0 in each step of alteration of the face image (S16). The second recognition unit 6 reads the second reference data set E2 from the storage unit 4 (S17), and carries out second recognition in which the positions of the eyes are detected in the face image (S18).

The first output unit 7 outputs the positions of the eyes and the distance d between the eyes recognized in the image D0 as the information S to the trimming unit 10 and to the comparison unit 40 (S19).

In the case where the image D0 has been judged to not include a face at Step S14 (S14: No), the first output unit 7 outputs the image D0 as it is to the output unit 50 (S19).

The trimming unit 10 cuts the predetermined ranges including the right eye and the left eye according to the information S input from the detection unit 1, and obtains the trimmed images D1a and D1b. The predetermined ranges for trimming refer to ranges surrounding the eyes. For example, each of the ranges may be a rectangular range represented by a hatched range shown in FIG. 16. The length in X direction is d while the length in Y direction is 0.5 d, and the center of the range is the center of the corresponding eye. In FIG. 16, only the hatched range for the left eye is shown, which is the same for the right eye.

The gray scale conversion unit 12 obtains the gray scale images D2 by carrying out gray-scale conversion on the trimmed images D1 obtained by the trimming unit 10, according to Equation (1) below:
Y=0.229×R+0.587×G+0.114×B (1)
where Y is brightness and R, G, and B are RGB values of the pixels.

The preprocessing unit 14 carries out the preprocessing on the gray scale images D2. The preprocessing is smoothing processing and filling processing. The smoothing processing is carried out by using a Gaussian filter, and the filling processing is interpolation processing.

Since an area above the center of each of the pupils tends to be partially brighter in a photograph image as shown in FIG. 4, data for this area are interpolated by the filling processing for improvement of detection accuracy regarding the center positions of pupils.

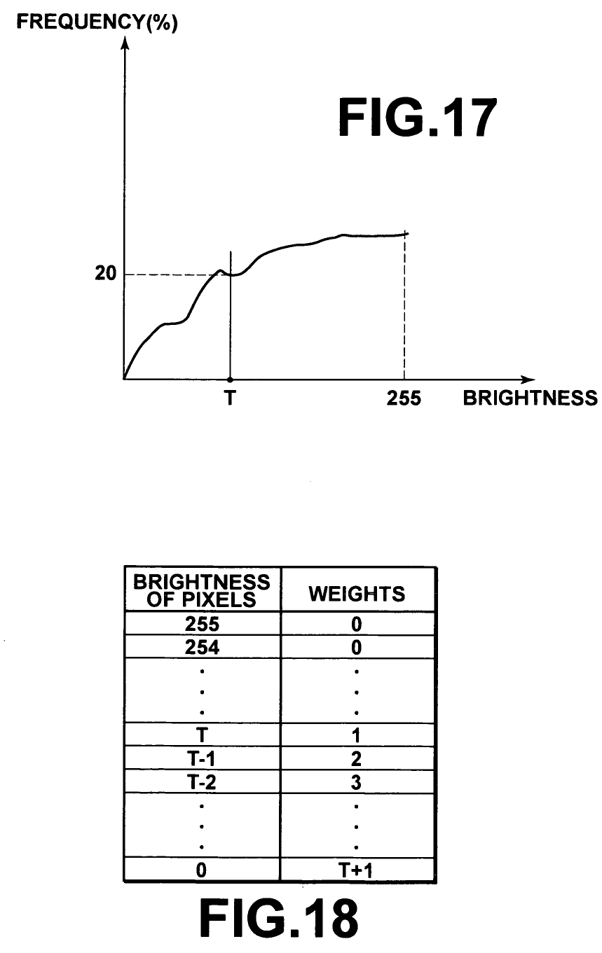

The binarization unit 20 has the binarization threshold calculation unit 18. Based on the threshold value T calculated by the binarization threshold calculation unit 18, the binarization unit 20 binarizes the preprocessed images D3 obtained by the preprocessing unit 14, and obtains the binarized images D4. More specifically, the binarization threshold calculation unit 18 generates a brightness histogram shown in FIG. 17 from the preprocessed images D3, and finds the threshold value T as the brightness value corresponding to frequency that is several times smaller than the total number of pixels in each of the preprocessed images D3. In FIG. 17, ⅕ (=20%) of the total number of pixels is used.

The voting unit 30 projects the coordinates of each of the pixels whose value is 1 in the binarized images D4 onto the space of Hough circle transform whose center and radius are (X, Y) and r, respectively. The votes at each of the points are then found. When one of the pixels votes for one of the point, 1 is added to the votes for the point. The votes at each of the points are generally counted in this manner. However, in this embodiment, when one of the pixels votes for one of the points, a weighted vote corresponding to the brightness of the pixel is added, instead of adding 1. In this case, the weight is set larger as the brightness becomes smaller. The votes are found for each of the points in this manner. FIG. 18 shows a table of the weight used by the voting unit 30 in the pupil detection means 100. The value T in the table is the threshold value T found by the binarization threshold calculation unit 18.

The voting unit 30 finds the votes at each of the points in this manner, and adds the votes at each of the points having the same (X, Y) coordinates in the space (X, Y, r) of Hough circle transform. The voting unit 30 finds the total votes W corresponding to the (X, Y) coordinates in this manner, and outputs the votes W in relation to the corresponding coordinates (X, Y) to the center position candidate acquisition unit 35.

The center position candidate acquisition unit 35 obtains the coordinates (X, Y) corresponding to the largest votes as the center position candidates G to be output to the comparison unit 40. The center position candidates G obtained by the center position candidate acquisition unit 35 comprises the center position Ga for the left eye and the center position Gb for the right eye, and the comparison unit 40 examines the positions Ga and Gb for agreement with the criteria, based on the distance d output from the detection unit 1.

More specifically, the comparison unit 40 examines the positions according to the following two criteria:

1. The difference in the Y coordinate between the center positions of the pupils is less than (d/50).

2. The difference in the X coordinate between the center positions of the pupils is within a range from 0.8×d to 1.2×d.

The comparison unit 40 judges whether the center position candidates Ga and Gb obtained by the center position candidate acquisition unit 35 satisfy the two criteria. In the case where the two criteria are satisfied, the comparison unit 40 outputs the center position candidates Ga and Gb as the center positions of the pupils to the fine adjustment unit 45. If either one of the criteria or both the criteria are not satisfied, the comparison unit 40 instructs the center position candidate acquisition unit 35 to newly obtain the center position candidates. The comparison unit 40 repeats the procedure of the examination of the center position candidates obtained newly by the center position candidate acquisition unit 35, output of the center positions in the case where the two criteria have been satisfied, and instruction of re-acquisition of the center position candidates by the center position candidate acquisition unit 35 in the case where the criteria have not been satisfied, until the two criteria are satisfied.

The center position candidate acquisition unit 35 fixes the center position of one of the pupils (the left pupil, in this case) upon instruction of re-acquisition of the center position candidates. The center position candidate acquisition unit 35 obtains the (X, Y) coordinates at the position satisfying the following three conditions from the votes Wb for the right pupil, and determines the coordinates as the center position thereof:

1. The distance between the newly found position and the position represented by the coordinates (X, Y) of the corresponding center position candidate output last time to the comparison unit 40 is d/30 or more.

2. The votes for the position are the second largest to the votes corresponding to the (X, Y) coordinates of the corresponding center position candidate output last time to the comparison unit 40, among the votes corresponding to the (X, Y) coordinates satisfying the condition 1 above.

3. The votes of the position are 10% or more of the votes (the largest votes) corresponding to the (X, Y) coordinate of the corresponding center position candidate output to the comparison unit 40 for the first time.

The center position candidate acquisition unit 35 finds the center position candidate for the right pupil satisfying the 3 conditions above according to the votes Wb thereof, while fixing the center position of the left pupil. In the case where the candidate satisfying the 3 conditions is not found, the center position candidate acquisition unit 35 fixes the center position of the right pupil and finds the center position of the left pupil satisfying the 3 conditions, based on the votes Wa thereof.

The fine adjustment unit 45 carries out fine adjustment of the center positions G (the center position candidates satisfying the criteria) output from the comparison unit 40. The fine adjustment for the left pupil will be described first. The fine adjustment unit 45 repeats mask operations 3 times on the binarized image D4a of the left pupil by using a mask of 9×9 elements whose values are all 1. Based on the position (hereinafter referred to as Gm) of the pixel having the largest value as a result of the operations, the fine adjustment unit 45 carries out the fine adjustment on the center position Ga of the left pupil output from the comparison unit 40. More specifically, the final center position G′ a may be the average between the positions Ga and Gm. Alternatively, the final center position G′a may be an average between a weighted Ga and Gm. In the example here, the center position Ga is weighted and averaged with Gm to find the position G′a.

The fine adjustment for the right pupil is carried out in the same manner as for the left pupil, by using the binarized image D4b thereof.

The fine adjustment unit 45 outputs the final center positions G′a and G′b obtained through the fine adjustment to the output unit 50.

The output unit 50 outputs the image D0 as it is to the blur analysis means 200 in the case where the image D0 does not include a face. In the case where the image D0 includes a face, the output unit 50 obtains the pupil images D5 (D5a and D5b) by cutting the predetermined ranges surrounding the center positions G′a and G′b. The pupil images D5 are output to the blur analysis means 200.

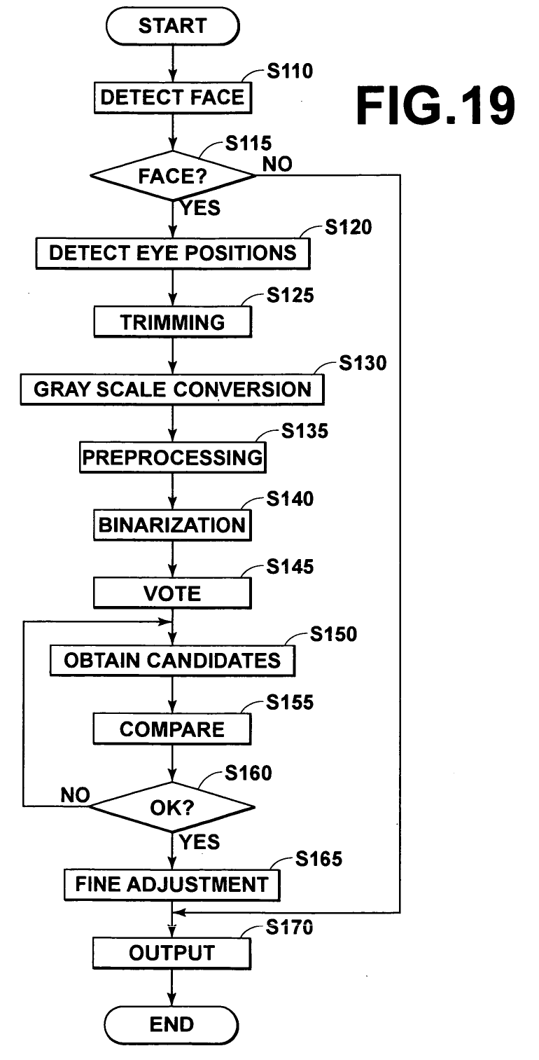

FIG. 19 is a flow chart showing a procedure carried out by the pupil detection means 100. As shown in FIG. 19, the detection unit 1 firstly judges whether the image D0 includes a face (S110). If no face is included (S115: No), the image D0 is output from the detection unit 1 to the output unit 50. In the case where the image D0 includes a face (S115: Yes), the detection unit 1 detects the eye positions in the image D0 and outputs the information S including the eye positions and the distance d between the eyes to the trimming unit 10 (S120). The trimming unit 10 trims the image D0, and obtains the trimmed image D1a for the left eye and the trimmed image D1b for the right eye (S125). The images D1 are subjected to the gray-scale conversion by the gray scale conversion unit 12, and the gray scale images D2 are obtained (S130). The gray scale images D2 are subjected to the smoothing processing and the filling processing by the preprocessing unit 14 (S135), and then binarized by the binarization unit 20 to generate the binarized images D4 (S140). The voting unit 30 projects the coordinates of each of pixels in the binarized images D4 onto the space of Hough circle transform, and obtains the total votes W corresponding to the (X, Y) coordinates of each of the points (S145). The center position candidate acquisition unit 35 outputs the (X, Y) coordinates corresponding to the largest votes as the center position candidates G to the comparison unit 40 (S150). The comparison unit 40 applies the criteria to the center position candidates Ga and Gb (S155). In the case where the center position candidates satisfy the criteria (S160: Yes), the comparison unit 40 outputs the center position candidates Ga and Gb as the center positions to the fine adjustment unit 45. In the case where the center position candidates do not satisfy the criteria (S160: No), the comparison unit 40 causes the center position candidate acquisition unit 35 to newly find the center position candidates (S150). The procedure from S150 to S160 is repeated until the comparison unit 40 finds that the center position candidates from the center position candidate acquisition unit 35 satisfy the criteria.

The fine adjustment unit 45 obtains the final center positions G′by carrying out the fine adjustment on the center positions G output by the comparison unit 40, and outputs the final center positions G′to the output unit 50 (S165).

The output unit 50 outputs the image D0 as it is to the blur analysis means 200 in the case where the image D0 does not include a face (S115: No). The output unit 50 cuts the predetermined ranges surrounding the final center positions G′a and G′b from the image D0 to obtain the pupil images D5 in the case where the image D0 includes a face, and outputs the pupil images D5 to the blur analysis means 200 (S170).

As has been described above, the image D0 not including a face or the pupil images D5 generated from the image D0 including a face are input to the blur analysis means 200 in the image processing system A shown in FIG. 1.

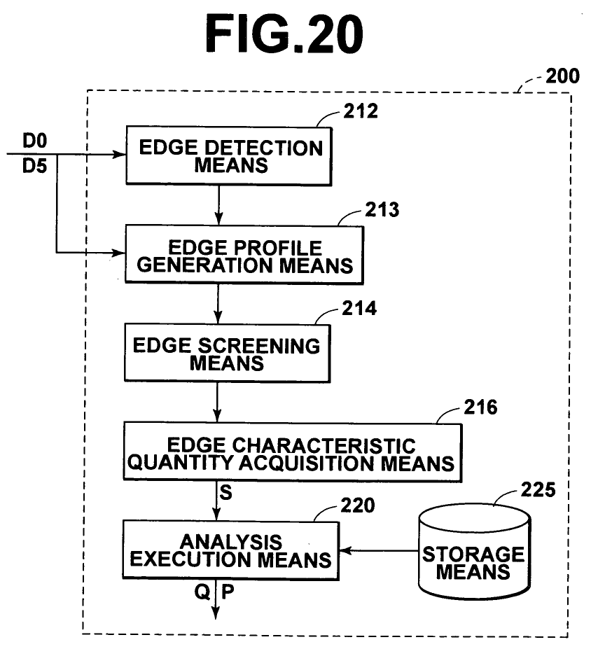

FIG. 20 is a block diagram showing the configuration of the blur analysis means 200. As shown in FIG. 20, the blur analysis means 200 comprises edge detection means 212, edge profile generation means 213, edge screening means 214, edge characteristic quantity acquisition means 216, analysis execution means 220, and storage means 225.

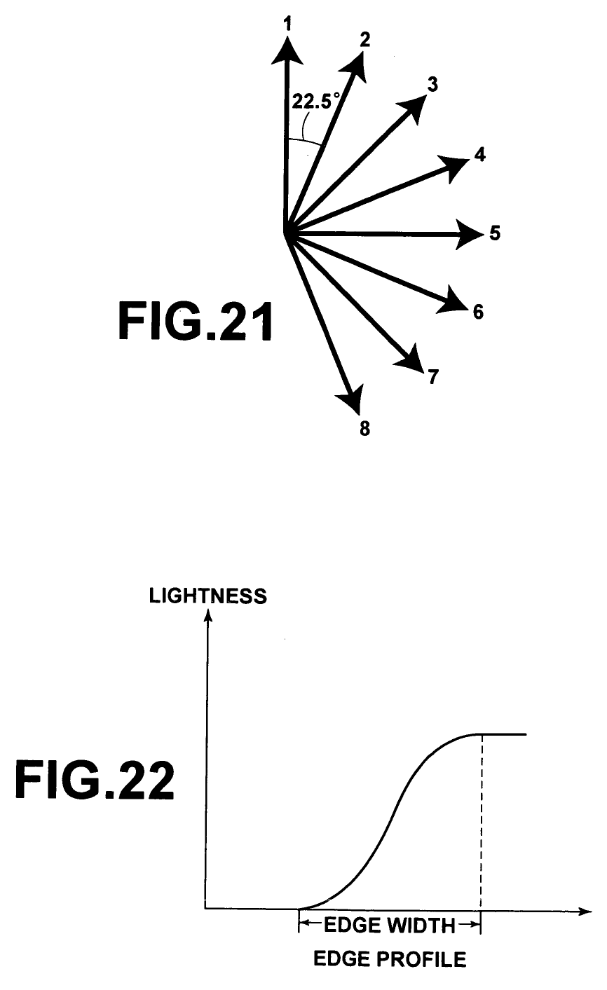

The edge detection means 212 detects edges of a predetermined strength or stronger in the image D0 or in the pupil images D5 (herein after referred to as a target image) in each of the 8 directions shown in FIG. 21. The edge detection means 212 outputs coordinates of the edges to the edge profile generation means 213. Based on the coordinates input from the edge detection means 212, the edge profile generation means 213 generates an edge profile such as an edge profile shown in FIG. 22, regarding each of the edges in each of the directions in the target image. The edge profile generation means 213 outputs the edge profiles to the edge screening means 214.

The edge screening means 214 eliminates an invalid part of the edges, such as an edge of complex profile shape and an edge including a light source (such as an edge with a predetermined lightness or brighter), based on the edge profiles input from the edge profile generation means 213. The edge screening means 214 outputs the edge profiles of the remaining edges to the edge characteristic quantity acquisition means 216.

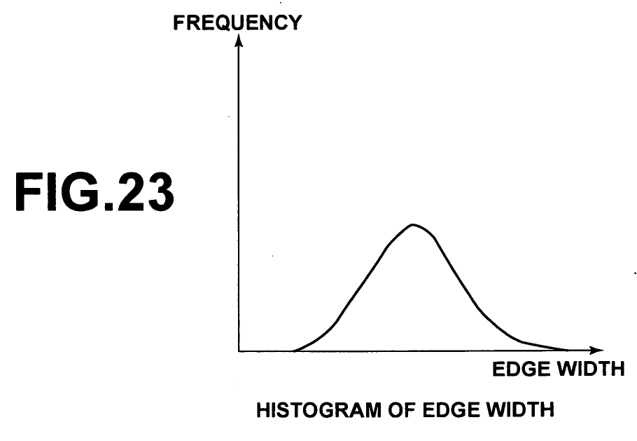

The edge characteristic quantity acquisition means 216 finds an edge width such as an edge width shown in FIG. 22, based on each of the edge profiles input from the edge screening means 214. The edge characteristic quantity acquisition means 216 generates histograms of the edge width, such as a histogram shown in FIG. 23, for the 8 directions shown in FIG. 21. The edge characteristic quantity acquisition means 216 outputs the histograms as characteristic quantities S to the analysis execution means 220, together with the edge width.

The analysis execution means 220 mainly carries out two types of processing described below.

1. Judgment as to whether or not the target image is a non-blur image or a blurry image, based on a degree N and a direction of blur in the target image.

2. Calculation of a width L of blur and a degree K of shake in the case of the target image being a blurry image.

The processing 1 will be described first.

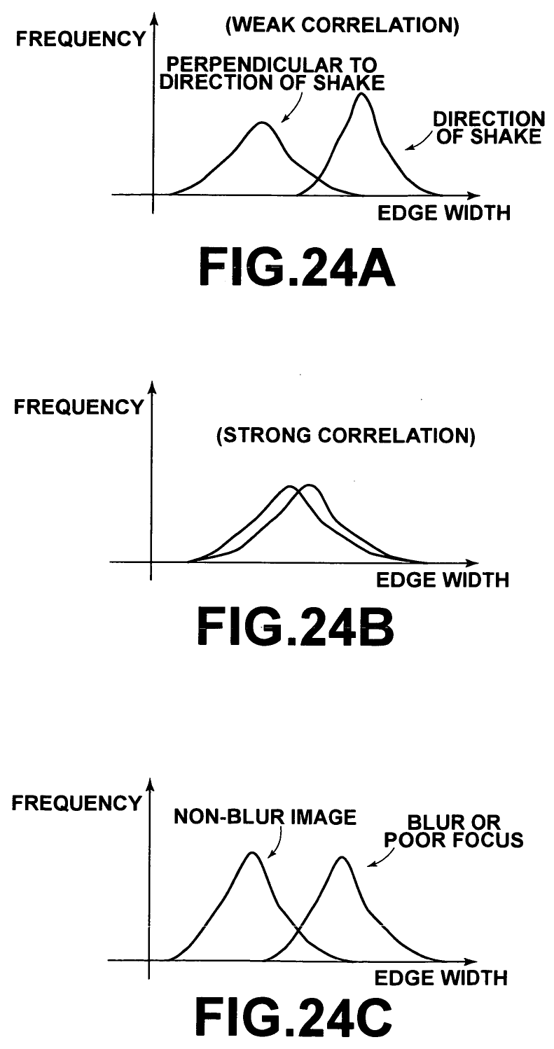

In order to find the direction of blur in the target image, the analysis execution means 220 finds a correlation value between the histograms of edge width in an orthogonal direction pair in the 8 directions shown in FIG. 21 (that is, in each of 4 pairs comprising directions 1 and 5, 2 and 6, 3 and 7, and 4 and 8). The correlation value may represent positive correlation or negative correlation. In other words, the larger the correlation value is, the stronger the correlation becomes in positive correlation. In negative correlation, the larger the correlation value is, the weaker the correlation becomes. In this embodiment, a value representing positive correlation is used. As shown in FIG. 24A, in the case where a shake is observed in an image, the correlation becomes weaker between the histogram in the direction of shake and the histogram in the direction perpendicular to the direction of shake. The correlation becomes stronger as shown in FIG. 24B between the histograms in the orthogonal direction pair including the directions other than the direction of shake and between the histograms in the orthogonal direction pair in the case of no shake in the image (that is, an image representing no shake or an image of poor focus). The analysis execution means 220 in the image processing system A in this embodiment pays attention to this trend, and finds the smallest value of correlation between the histograms among the 4 pairs of the directions. If the target image represents a shake, one of the two directions in the pair found as the pair of smallest correlation value represents the direction closest to the direction of shake.

FIG. 24C shows histograms of edge width in the direction of shake found from images of the same subject with a shake, poor focus, and no blur (without shake and without poor focus). As shown in FIG. 24C, the non-blur image has the smallest average edge width. In other words, one of the two directions having the larger average edge width in the pair represents the direction closest to the direction of shake.

The analysis execution means 220 finds the pair of weakest correlation, and determines the direction of the larger average edge width as the direction of blur.

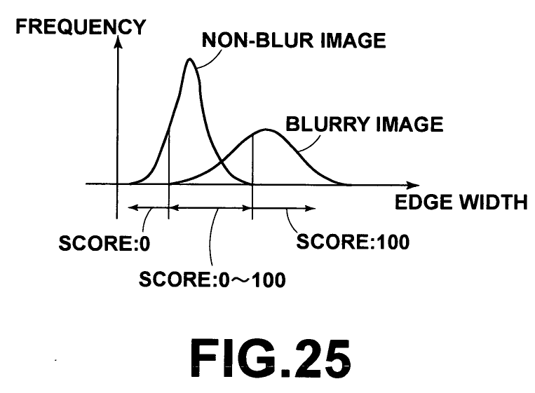

The analysis execution means 220 also finds the degree N of blur in the target image. The degree N represents a degree of how the image is blurry. The degree N may be found by using the average edge width in the blurriest direction (the direction of blur found in the above manner). However, in this embodiment, the degree N is found more accurately based on FIG. 25, by using the edge width in the direction of blur. In order to generate FIG. 25, histograms of edge width in the blurriest direction are generated, based on a non-blur image database and a blurry image (caused by shake and poor focus) database. In the case of non-blur images, although the blurriest direction is preferably used, an arbitrary direction may be used for generation of the histograms in FIG. 25. A score (an evaluation value) is found as a ratio of frequency of edge width (represented by the vertical axis) between blurry images and non-blur images. Based on FIG. 25, a database (hereinafter referred to as a score database) relating the edge width and the score is generated, and stored in the storage means 225.

The analysis execution means 220 refers to the score database stored in the storage means 225, and obtains the score of edge width regarding all the edges in the direction of blur in the target image. The analysis execution means 220 finds an average of the score of edge width in the direction of blur as the degree N of blur in the target image. In the case where the degree N for the target image is smaller than a predetermined threshold value T1, the analysis execution means 220 judges that the image D0 corresponding to the target image is a non-blur image. Therefore, the analysis execution means 220 sends the information P representing the fact that the image D0 is a non-blur image to the output means 270 to end the procedure.

In the case where the degree N of blur for the target image is not smaller than the threshold value T1, the analysis execution means 220 judges that the target image is a blurry image, and carries out the processing 2 described above.

As the processing 2, the analysis execution means 220 finds the degree K of shake for the target image.

The degree K representing magnitude of shake in a blur can be found according to the following facts:

1. The smaller the value of correlation in the pair of the directions of weakest correlation (hereinafter referred to as the weakest correlation pair), the larger the degree of shake is.

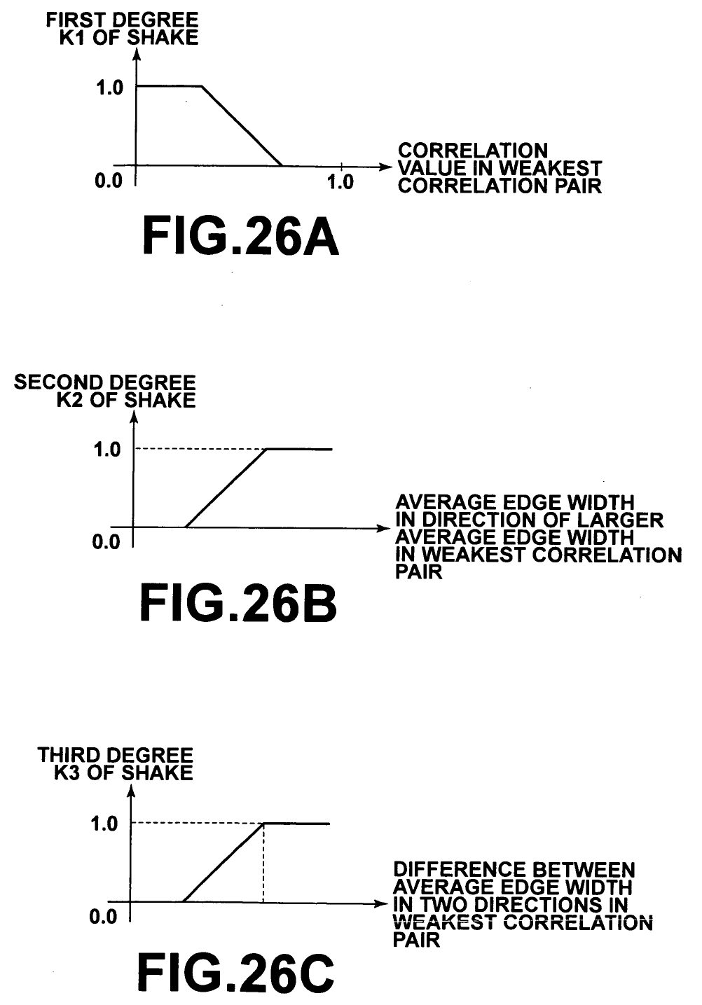

The analysis execution means 220 pays attention to this fact, and finds a first degree K1 of shake based on a graph shown in FIG. 26A. A lookup table (LUT) generated according to the graph shown in FIG. 26A is stored in the storage means 225, and the analysis execution means 220 reads the first degree K1 of shake corresponding to the value of correlation of the weakest correlation pair from the storage means 225.

2. The larger the average edge width in the direction of larger edge with in the weakest correction pair, the larger the degree of shake is.

The analysis execution means 220 pays attention to this fact, and finds a second degree K2 of shake based on a graph shown in FIG. 26B. A lookup table (LUT) generated according to the graph shown in FIG. 26B is stored in the storage means 225, and the analysis execution means 220 reads the second degree K2 of shake corresponding to the average edge width in the direction of larger edge width in the weakest correlation pair from the storage means 225.

3. The larger the difference in the average edge width in the two directions in the weakest correlation pair, the larger the degree of shake is.

The analysis execution means 220 pays attention to this fact, and finds a third degree K3 of shake based on a graph shown in FIG. 26C. A lookup table (LUT) generated according to the graph shown in FIG. 26C is stored in the storage means 225, and the analysis execution means 220 reads the third degree K3 of shake corresponding to the difference in the average edge width in the two directions in the weakest correlation pair from the storage means 225.

The analysis execution means 220 finds the degrees K1, K2 and K3 of shake in the above manner, and finds the degree K of shake for the target image according to the following Equation (2) using the degrees K1 to K3:
K=K1×K2×K3 (2)

The analysis execution means 220 then finds the width L of blur in the target image judged as a blurry image. The average edge width in the direction of blur may be found as the width L of blur, regardless of the degree K of shake. Alternatively, the average edge width in the 8 directions may be found as the width L of blur.

In this manner, the analysis execution means 220 finds the degree K of shake and the width L of blur for the target image, and outputs the degree K and the width L as the blur information Q for the image D0 corresponding to the target image to the deblurring means 230, together with the direction of blur.

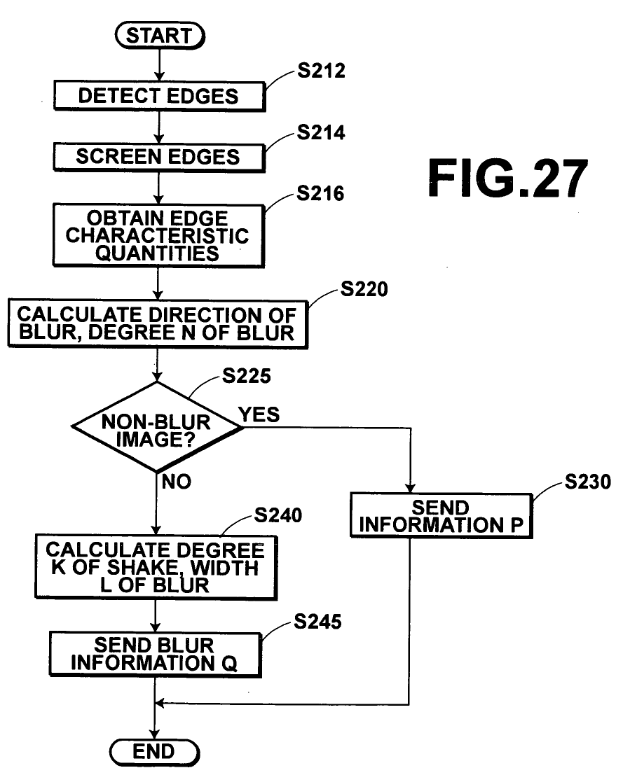

FIG. 27 is a flow chart showing a procedure carried out by the blur analysis means 200 shown in FIG. 20. As shown in FIG. 27, the edge detection means 212 detects the edges of the predetermined strength or higher in the 8 directions, based on the target image. The edge detection means 212 obtains the coordinates of the detected edges, and the edge profile generation means 213 generates the edge profiles for the edges in the target image according to the coordinates. The edge profile generation means 213 outputs the edge profiles to the edge screening means 214 (S212). The edge screening means 214 eliminates the invalid edges by using the edge profiles sent by the edge profile generation means 213, and outputs the edge profiles of the remaining edges to the edge characteristic quantity acquisition means 216 (S214). The edge characteristic quantity acquisition means 216 finds the edge width according to each of the edge profiles sent from the edge screening means 214, and generates the edge width histograms in the 8 directions. The edge characteristic quantity acquisition means 216 then outputs the edge width and the histograms in the respective directions as the characteristic quantities S of the target image to the analysis execution means 220 (S216). The analysis execution means 220 finds the degree N and the direction of blur in the target image with reference to the edge characteristic quantities S (S220), and judges whether the image D0 is a non-blur image or a blurry image (S225). In the case where the image D0 is a non-blur image (S225: Yes), the analysis execution means 220 outputs the information P representing this fact to the output means 270 (S230). In the case where the image D0 is a blurry image (S225: No), the analysis execution means 220 finds the width L of blur and the degree K of shake in the target image (S240), and outputs the blur information Q including the degree K of shake and the width L of blur as well as the degree N and the direction of blur found at Step S220 to the deblurring means 230 (S245).

In this embodiment, the blur analysis means 200 carries out the analysis by using the two pupil images D5a and D5b. However, either one of the pupil images may be used alone.

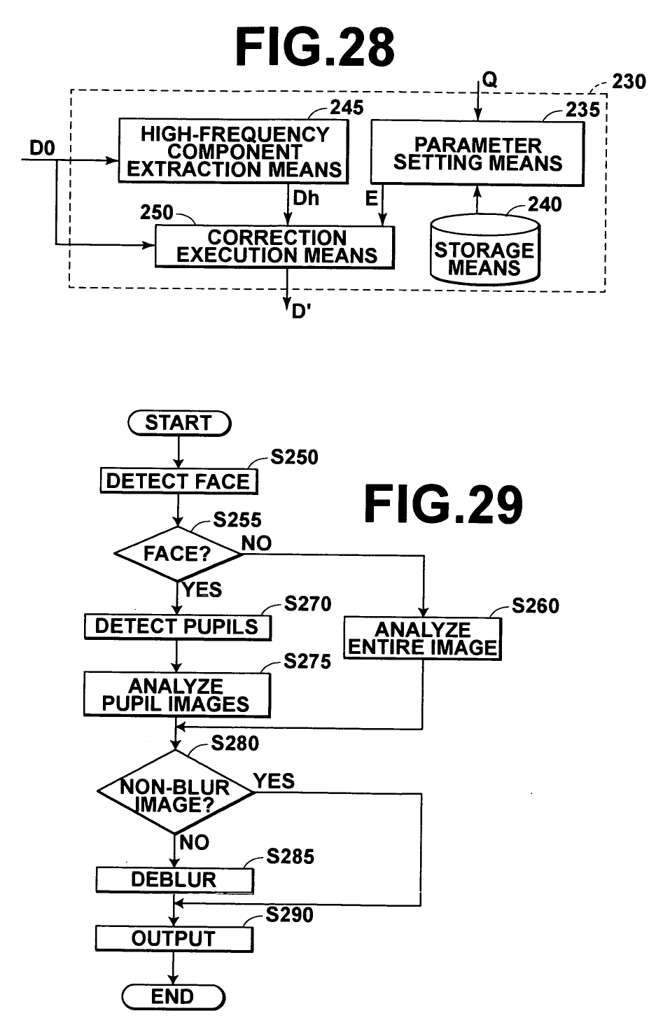

The deblurring means 230 deblurs the image D0 judged as a blurry image, based on the blur information Q obtained by the blur analysis execution means 220. FIG. 28 is a block diagram showing the configuration of the deblurring means 230.

As shown in FIG. 28, the deblurring means 230 comprises parameter setting means 235 for setting parameters E for correction of the image D0 according to the blur information Q, storage means 240 for storing various kinds of databases for the parameter setting means 235, high-frequency component extraction means 245 for extracting high frequency components Dh from the image D0, and correction execution means 250 for deblurring the image D0 by using the parameters E and the high-frequency components Dh.

The deblurring means 230 in the image processing system A in this embodiment carries out the correction on the image D0 judged as a blurry image, by using an unsharp masking (USM) method. The parameter setting means 235 sets a one-dimensional correction mask M1 for correcting directionality in the direction of blur according to the width L and the direction of blur in such a manner that the larger the width L becomes, the larger a size of the mask M1 becomes. The parameter setting means 235 also sets a two-dimensional correction mask M2 for isotropic correction in such a manner that the larger the width L becomes the larger a size of the mask M2 becomes. Two-dimensional masks corresponding to the width L of any value and one-dimensional masks corresponding to the width L of any value and any direction of blur are stored in a mask database in the storage means 240. The parameter setting means 235 obtains the one-dimensional mask M1 based on the width L and the direction of blur, and the two-dimensional mask M2 based on the width L of blur from the mask database in the storage means 240.

The parameter setting means 235 sets a one-dimensional correction parameter W1 for correcting directionality and a two-dimensional correction parameter W2 for isotropic correction according to Equations (3) below:
W1=N×K×M1
W2=N×(1−K)×M2 (3)

As shown by Equations (3) above, the parameter setting means 235 sets the parameters W1 and W2 (collectively referred to as the parameters E) in such a manner that strength of isotropic correction and directionality correction becomes higher as the degree N becomes larger and a weight of the directionality correction becomes larger as the degree K of shake becomes larger.

The correction execution means 250 deblurs the image D0 by emphasizing the high-frequency components Dh obtained by the high-frequency component extraction means 245, by using the parameters E set by the parameter setting means 235. More specifically, the image D0 is deblurred according to Equation (4) below:
D′=D0+E×Dh (4)

The output means 270 outputs the image D0 in the case where the information P representing that the image D0 is a non-blur image is received from the blur analysis means 200. In the case where the output means 270 receives the corrected image D′ from the deblurring means 230, the output means 270 outputs the corrected image D′. In the image processing system A in this embodiment, the output means 270 outputs the image D0 or the corrected image D′ by printing thereof. In this manner, the print of the image D0 or D′ can be obtained. However, the output means 270 may record the image D0 or D′ in a recording medium or may send the image D0 or D′ to an image storage server on a network or to an address on a network specified by a person who requested the correction of the image.

FIG. 29 is a flow chart showing a procedure carried out by the image processing system A in this embodiment. As shown in FIG. 29, the pupil detection means 100 detects a face in the image D0 (S250). In the case where no face has been detected (S255: No), the blur analysis means 200 carries out the blur analysis by using the entire data of the image D0 (S260). In the case where a face has been detected (S255: Yes), the pupil detection means 100 detects the pupils and obtains the pupil images D5 (S270). The blur analysis means 200 carries out the blur analysis by using the image data of the pupil images (S275).

The blur analysis means 200 outputs the information P representing that the image D0 is a non-blur image in the case where the image D0 has been judged to be a non-blur image through the analysis of the image D0 or the pupil images D5 (S280: Yes). The output means 270 then prints the image D0 (S290). In the case where the image D0 has been judged to be a blurry image (S280: No), the blur information Q found on the image D0 is output to the deblurring means 230. The deblurring means 230 carries out the correction on the image D0 based on the blur information Q (S285). The corrected image D′ obtained by the deblurring means 230 is also output by the output means 270 (S290).

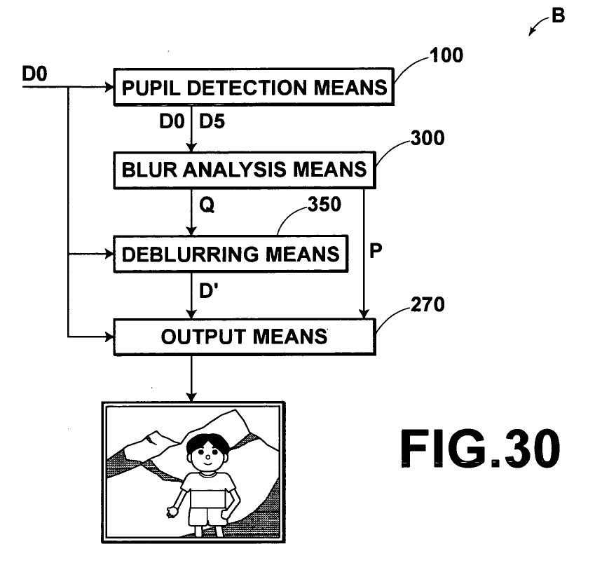

FIG. 30 is a block diagram showing the configuration of an image processing system B of a second embodiment of the present invention. As shown in FIG. 30, the image processing system B in this embodiment has pupil detection means 100, blur analysis means 300, deblurring means 350, and output means 270. Although the blur analysis means 300 and the deblurring means 350 are different from the blur analysis means and the deblurring means in the image processing system A in the first embodiment, the remaining means are the same as in the image processing system A. Therefore, the same reference numbers are used for the same means, and detailed description thereof will be omitted.

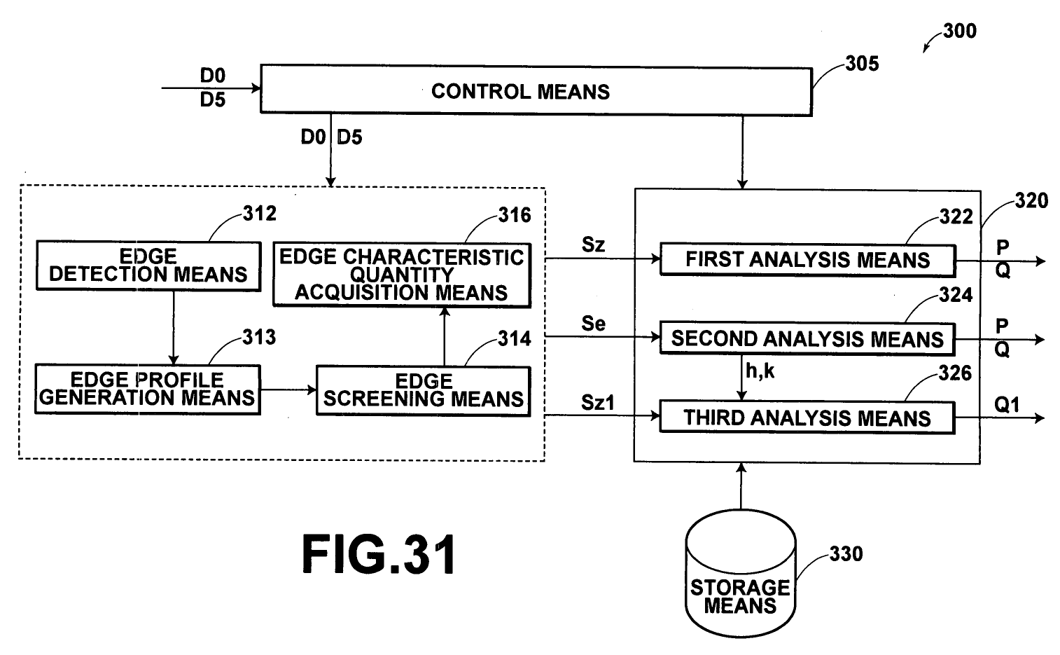

FIG. 31 is a block diagram showing the configuration of the blur analysis means 300 in the image processing system B. As shown in FIG. 31, the blur analysis means 300 comprises edge detection means 312, edge profile generation means 313, edge screening means 314, edge characteristic quantity acquisition means 316, analysis means 320, storage means 330 for storing various kinds of databases for the analysis means 320, and control means 305 for controlling the means described above. The analysis means 320 comprises first analysis means 322, second analysis means 324, and third analysis means 326.

The control means 305 in the blur analysis means 300 controls the means based on whether a face has been detected by the pupil detection means 100. In the case where a face has not been detected by the pupil detection means 100, the control means 305 causes the edge detection means 312 to detect edges in the image D0. Since the operation of the edge detection means 312, the edge profile generation means 313, the edge screening means 314, and the edge characteristic quantity acquisition means 316 is the same as in the corresponding means in the blur analysis means 200 in the image processing system A, detailed description thereof will be omitted. The edge profile generation means 313, the edge screening means 314, and the edge characteristic quantity acquisition means 316 carry out the processing on the edges detected by the edge detection means 312, and characteristic quantities Sz for the image D0 are obtained. The characteristic quantities Sz and characteristic quantities Se that will be described later comprise the edge width and the histograms of edge width in the different directions, as in the case of the characteristic quantities S in the image processing system A in the first embodiment.

The control means 305 causes the first analysis means 322 to analyze the edge characteristic quantities Sz. The first analysis means 322 judges whether or not the image D0 is a blurry image, based on the edge characteristic quantities Sz. In the case where the image D0 is a non-blur image, the first analysis means 322 outputs the information P to the output means 270. In the case where the image D0 is a blurry image, the first analysis means 322 sends the information Q to the deblurring means 350. The operation of the first analysis means 322 is the same as the operation of the analysis execution means 220 in the blur analysis means 200 in the image processing system A.

In the case where the pupil detection means 100 has detected a face or pupils and obtained the pupil images D5, the control means 305 causes the edge detection means 312 to detect the edges in the pupil images D5. The edge profile generation means 313, the edge screening means 314, and the edge characteristic quantity acquisition means 316 respectively carry out the processing on the edges detected by the edge detection means 312, and obtains the characteristic quantities Se in the pupil images D5.

The control means 305 causes the second analysis means 324 to judge whether or not the pupil images D5 are blurry images, and further causes the second analysis means 324 to analyze whether the images D5 have been blurred by poor focus or shake, in the case where the images D5 have been judged to be blurry. The second analysis means 324 finds the direction (hereinafter referred to as h) and the degree N of blur according to the characteristic quantities Se of the pupil images D5 in the same manner as the analysis execution means 220 in the blur analysis means 200 in the first embodiment. In the case where the degree N is less than the threshold value T1, the second analysis means 324 judges that the image D0 corresponding to the pupil images D5 is a non-blur image. The second analysis means 324 then outputs the information P to the output means 270. In the case where the degree N greater than or equal to the threshold value T1, the second analysis means 324 judges that the image D0 is a blurry image. The second analysis means 324 then finds the degree K of shake. The degree K of shake is found by the second analysis means 324 in the same manner as by the analysis execution means 220. The second analysis means 324 judges whether the image D0 corresponding to the pupil images D5 have been blurred by poor focus or shake, based on the degree K of shake. More specifically, in the case where the degree K is not larger than a predetermined threshold value T2, the image D0 is judged to be an image of poor focus (hereinafter referred to as out-of-focus image). Otherwise, the image D0 is judged to be an image representing shake (hereinafter referred to as a shake image).

The second analysis means 324 finds the width L of blur from the characteristic quantities Se of the pupil images D5 corresponding to the image D0 having been judged as an out-of-focus image. The second analysis means 324 outputs the information Q including information representing that the image D0 is an out-of-focus image and the width L of blur to the deblurring means 350.

The second analysis means 324 sends the direction of blur (that is, the direction h of shake, in this case) to the third analysis means 326 for the image D0 having been judged to be a shake image. In the case where the image D0 has been judged to be a shake image, the control means 305 causes the edge detection means 312 to detect the edges in the direction h, regarding the entire image D0. The edge profile generation means 313 and the edge screening means 314 carry out the processing on the edges in the direction h, and the edge profiles in the direction h in the image D0 are obtained as characteristic quantities Sz1.

The third analysis means 326 calculates the average edge width in the direction h as a length of shake from the edge profiles used as the characteristic quantities Sz1, and sends blur information Q1 including information representing that the image D0 is a shake image and the length and the direction h of shake to the deblurring means 350.

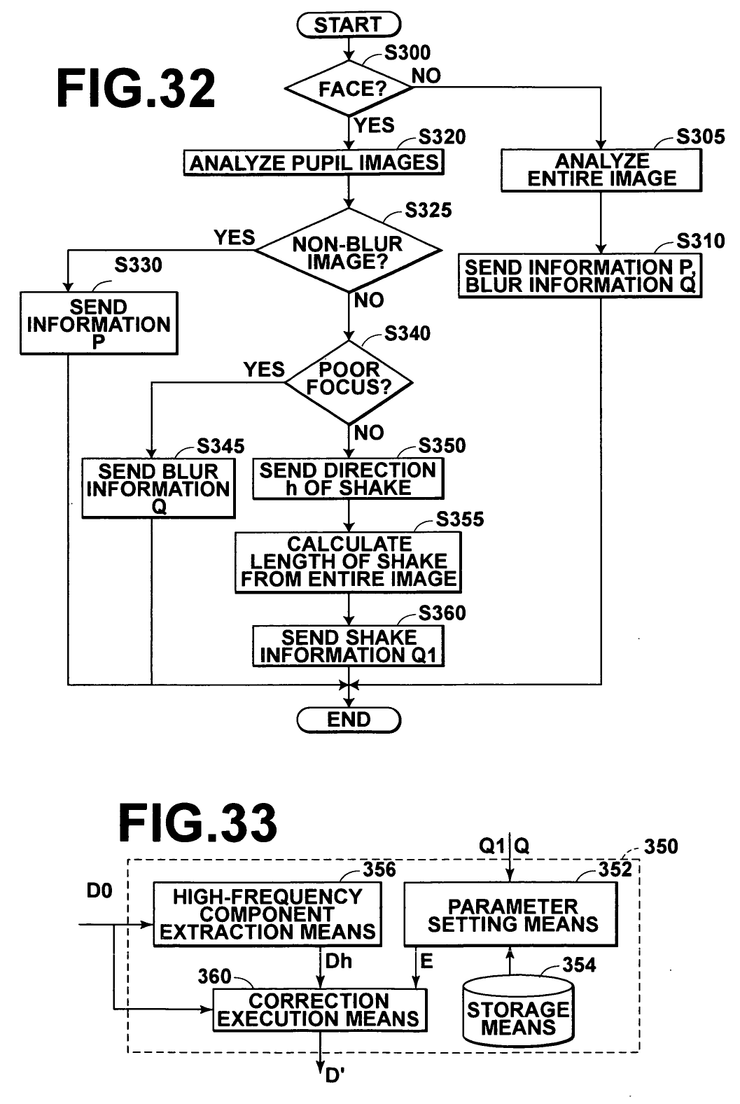

FIG. 32 is a flow chart showing a procedure carried out by the blur analysis means 300. As shown in FIG. 32, the control means 305 in the blur analysis means 300 causes the edge detection means 312 to detect the edges in the 8 directions shown by FIG. 21 in the entire image D0 in which no face has been detected by the pupil detection means 100 (S300: No). The edge profile generation means 313, the edge screening means 314, and the edge characteristic quantity acquisition means 316 respectively carry out the processing on the detected edges, and the edge characteristic quantities Sz of the image D0 are obtained. The first analysis means 322 judges whether or not the image D0 is a non-blur image by finding the direction and the degree N of blur in the image D0 with reference to the characteristic quantities Sz (S305). The first analysis means 322 outputs the information P representing that the image D0 is a non-blur image to the output means 270 in the case where the image D0 has been judged to be a non-blur image. In the case where the image D0 has been judged to be blurry, the first analysis means 322 finds the width L of blur and the degree K of shake, and outputs the blur information Q comprising the width L of blur and the degree K of shake as well as the direction and the degree N of blur to the deblurring means 350 (S310).

In the case where the pupil detection means 100 has detected a face or pupils in the image D0 (S300: Yes), the control means 305 causes the edge detection means 312 to detect the edges in the 8 directions in the pupil images D5 of the image D0. The edge profile generation means 313, the edge screening means 314, and the edge characteristic quantity acquisition means 316 respectively carry out the processing on the edges detected by the edge detection means 312, and the characteristic quantities Se in the pupil images D5 are obtained (S320). The second analysis means 324 judges whether or not the pupil images D5 are blurry images by finding the direction of blur and the degree N of blur in the images D5 with reference to the characteristic quantities Se. The second analysis means 324 outputs the information P representing that the image D0 is a non-blur image to the output means 270 (S330) in the case where the image D0 has been judged to be a non-blur image (S325: Yes). For the image D0 having been judged to be blurry at Step S325 (S325: No), the second analysis means 324 judges whether the image D0 is an out-of-focus image or a shake image (S340). In the case of out-of-focus image (S340: Yes), the second analysis means 324 finds the width of blur in the image D0 from the characteristic quantities Se of the pupil images D5 of the image D0, and outputs the blur information Q comprising the width of blur and information representing that the image D0 is an out-of-focus image to the deblurring means 350 (S345). In the case of shake image (S340: No), the second analysis means 324 sends the direction h of shake to the third analysis means 326 (S350). The third analysis means 326 finds the average edge width in the direction h as the length of shake (S355), by using the characteristic quantities Sz1 in the direction h found from the entire image D0 corresponding to the pupil images D5 by the edge detection means 312, the edge profile generation means 313, edge screening means 314, and the edge characteristic quantity acquisition means 316. The third analysis means 326 outputs the blur information Q1 of the shake image D0 including the length of shake, the direction h of shake, and the information representing that the image D0 is a shake image (S360).

As has been described above, the deblurring means 350 receives 3 types of the blur information Q. The blur information may be first blur information comprising the degree N and the width L of blur and the length K of shake obtained by the first analysis means 322 based on the entire image D0 in which no face has been detected. The blur information may be second blur information comprising the information representing that the image D0 is an out-of-focus image and the width of blur obtained by the second analysis means 324 based on the pupil images D5 of the image D0 in which a face or pupils have been detected. The blur information can also be third blur information as the blur information Q1 comprising the information representing that the image D0 is a shake image, the length of shake in the direction h of shake obtained by the third analysis means 326 based on the entire image D0, and the direction h of shake found by the second analysis means 324 from the pupil images D5 of the image D0.

FIG. 33 is a block diagram showing the configuration of the deblurring means 350. As shown in FIG. 33, the deblurring means 350 comprises parameter setting means 352 for setting the parameters E according to the blur information from the blur analysis means 300, storage means 354 for storing various kinds of databases for the parameter setting means 352, high-frequency component extraction means 356 for extracting the high frequency components Dh from the image D0, and correction execution means 360 for deblurring the image D0 by adding the high frequency components Dh emphasized by using the parameters E to the image D0.

Upon reception of the first blur information Q, the parameter setting means 352 sets the one-dimensional correction mask M1 for correcting directionality in the direction of blur according to the width L and the direction of blur in the blur information Q in such a manner that the larger the width L becomes, the size of the mask M1 becomes, as in the case of the parameter setting means 235 in the deblurring means 230 in the image processing system A in the first embodiment. The parameter setting means 352 also sets the two-dimensional correction mask M2 for isotropic correction in such a manner that the larger the width L becomes the larger the size of the mask M2 becomes. Two-dimensional masks corresponding to the width L of any value and one-dimensional masks corresponding to the width L of any value and any direction of blur are stored in a mask database in the storage means 354. The parameter setting means 352 obtains the one-dimensional mask M1 based on the width L and the direction of blur, and the two-dimensional mask M2 based on the width L of blur from the mask database in the storage means 354.

The parameter setting means 352 sets the one-dimensional correction parameter W1 for correcting directionality and the two-dimensional correction parameter W2 for isotropic correction according to Equations (3) below:
W1=N×K×M1
W2=N×(1−K)×M2 (3)

As shown by Equations (3) above, the parameter setting means 352 sets the parameters W1 and W2 (collectively referred to as the parameters E) in such a manner that strength of isotropic correction and directionality correction becomes higher as the degree N becomes larger and the a weight of directionality correction becomes larger as the degree K of shake becomes larger.

Upon reception of the second blur information Q, the parameter setting means 352 reads from the storage means 354 the isotropic two-dimensional correction mask M2 for correcting poor focus according to the width of blur included in the blur information Q, and sets the mask M2 as the parameters E for the out-of-focus image D0.

Upon reception of the blur information Q1 as the third blur information, the parameter setting means 352 reads the one-dimensional correction mask M1 having the directionality according to the width of shake and the direction h of shake included in the blur information Q1 from the storage means 354 for correcting a blur, and sets the mask M1 as the parameters E.

The correction execution means 360 deblurs the image D0 by emphasizing the high-frequency components Dh according to the parameters E, as in the case of the correction execution means 250 in the deblurring means 230 in the image processing system A in the first embodiment. More specifically, the image D0 is deblurred according to Equation (4) below:
D′=D0+E×Dh (4)

The corrected image D′ obtained by the deblurring means 350 or the image D0 as a non-blur image is printed by the output means 270.

1. An image processing method for obtaining blur information representing a state of a blur in a digital photograph image, the image processing method comprising the steps of:
detecting a point-like part in the digital photograph image; and
obtaining the blur information of the digital photograph image by using data of an image of the point-like part.

2. The image processing method according to claim 1, wherein the digital photograph image is a photograph image of a person and the point-like part is a pupil of the person.

3. The image processing method according to claim 1, wherein the digital photograph image is a photograph image of a person, and the point-like part is an outline of the person's face.

4. The image processing method according to claim 1, wherein:
the blur information includes information on a direction of the blur, the information on the direction of the blur comprising information representing whether the blur has been caused by poor focus resulting in no directionality of the blur or shake resulting in directionality of the blur, and information representing a direction of the shake in the case where the blur has been caused by the shake, and
the step of obtaining the blur information comprises the steps of obtaining the information on the direction of the blur by using the data of the image of the point-like part, and obtaining the blur information other than the information on the direction of the blur by using entire data of the digital photograph image based on the information on the direction of the blur representing that the blur has been caused by the shake.

5. The image processing method according to claim 4, wherein
the step of obtaining the blur information comprises the steps of:
detecting an edge in different directions in the image of the point-like part;
obtaining a characteristic quantity of the edge in each of the directions; and
obtaining the information on the direction of the blur, based on the characteristic quantity in each of the directions.

6. The image processing method according to claim 4, wherein the step of obtaining the blur information comprises the steps of:
detecting an edge in different directions in the image of the point-like part;
obtaining a characteristic quantity of the edge in each of the directions; and
obtaining the information on the direction of the blur, based on the characteristic quantity in each of the directions.

7. The image processing method according to claim 1, further comprising the step of:
correcting the digital photograph image to eliminate blur, after obtaining the blur information.

8. An image processing apparatus for obtaining blur information representing a state of a blur in a digital photograph image, the image processing apparatus comprising:
point-like part detection means for detecting a point-like part in the digital photograph image; and
analysis means for obtaining the blur information of the digital photograph image by using data of an image of the point-like part.

9. The image processing apparatus according to claim 8, wherein the digital photograph image is a photograph image of a person and the point-like part detection means detects a pupil or a facial outline of the person as the point-like part.

10. The image processing apparatus according to claim 8, wherein:
the blur information includes information on a direction of the blur, the information on the direction of the blur comprising information representing whether the blur has been caused by poor focus resulting in no directionality of the blur or shake resulting in directionality of the blur, and information representing a direction of the shake in the case where the blur has been caused by the shake, and
the analysis means obtains the information on the direction of the blur by using the data of the image of the point-like part, and obtaining the blur information other than the information on the direction of the blur by using entire data of the digital photograph image based on the information on the direction of the blur representing that the blur has been caused by the shake.

11. The image processing apparatus according to claim 10, wherein
the analysis means detects an edge in different directions in the image of the point-like part;
obtains a characteristic quantity of the edge in each of the directions; and
obtains the information on the direction of the blur based on the characteristic quantity in each of the directions.

12. The image processing apparatus according to claim 8, further comprising:
correction means, for correcting the digital photograph image, after the analysis means obtains the blur information.

13. the image processing apparatus according to claim 12, wherein:
the correction means increases the degree of correction as the size of the point-like part increases.

14. A program for causing a computer to execute processing for obtaining blur information representing a state of a blur in a digital photograph image, the processing comprising:
point-like part detection processing for detecting a point-like part in the digital photograph image; and
analysis processing for obtaining the blur information of the digital photograph image by using data of an image of the point-like part.

15. The program according to claim 14 wherein the digital photograph image is a photograph image of a person and the point-like part is a pupil of the person.

16. The program according to claim 14, wherein:
the blur information includes information on a direction of the blur, the information on the direction of the blur comprising information representing whether the blur has been caused by poor focus resulting in no directionality of the blur or shake resulting in directionality of the blur, and information representing a direction of the shake in the case where the blur has been caused by the shake, and
the analysis processing comprises processing for obtaining the information on the direction of the blur by using the data of the image of the point-like part, and processing for obtaining the blur information other than the information on the direction of the blur by using entire data of the digital photograph image based on the information on the direction of the blur representing that the blur has been caused by the shake.

17. The program according to claim 16, wherein the analysis processing comprises processing for:
detecting an edge in different directions in the image of the point-like part;
obtaining a characteristic quantity of the edge in each of the directions; and
obtaining the information on the direction of the blur, based on the characteristic quantity in each of the directions.

18. The program according to claim 15, wherein the analysis processing comprises processing for:
detecting an edge in different directions in the image of the point-like part;
obtaining a characteristic quantity of the edge in each of the directions; and
obtaining the information on the direction of the blur, based on the characteristic quantity in each of the directions.
